(19) United States
(12) Patent Application Publication
(10) Pub. No.: US 2026/0049849 A1
(43) Pub. Date: Feb. 19, 2026

(54) SENSOR SYSTEM FOR GRAIN STORAGE DEVICES

(71) Applicant: SUKUP MANUFACTURING CO., Sheffield, IA (US)

(72) Inventors: David Brownmiller, Mason City, IA (US); Dustin Platte, Sheffield, IA (US); Casey Heilskov, Hampton, IA (US); Daniel Wayne Shrock, Raymondville, MO (US); Matthew Koch, Clear Lake, IA (US)

(21) Appl. No.: 19/368,350

(22) Filed: Oct. 24, 2025

Related U.S. Application Data
(63) Continuation-in-part of application No. 17/895,376, filed on Aug. 25, 2022.
(60) Provisional application No. 63/237,565, filed on Aug. 27, 2021.
(60) Provisional application No. 63/712,794, filed on Oct. 28, 2024.

(51) Int. Cl. G01D 11/30; G01D 11/24

(52) U.S. Cl. CPC G01D 11/30; G01D 11/245

(57) ABSTRACT

A sensor system for a grain storage device is presented. The sensor system includes a sensor cable and a roof access port configured to be installed over an opening in a roof of the grain bin that is positioned above the sensor cable. The roof access port includes a housing having a hollow interior and a cover. In one or more arrangements, the system includes a control module positioned in the hollow interior. The control module is communicatively connected to the sensor cable and is configured to receive sensor data from the sensor cable.

### CROSS-REFERENCE TO RELATED APPLICATIONS

This application claims priority to U.S. Provisional Application 63/712,794, titled SENSOR SYSTEM FOR GRAIN STORAGE DEVICES, and filed on Oct. 28, 2024, the entirety of which is hereby incorporated by reference herein, including any figures, tables, drawings, or other information. This application is a continuation-in-part of U.S. patent application Ser. No. 17/895,376 (published as U.S. Pub. No. 2023/0067298), titled SENSOR SYSTEM FOR GRAIN STORAGE DEVICES, and filed on Aug. 25, 2022, which claims priority to U.S. Provisional Application 63/237,565, titled SENSOR SYSTEM FOR GRAIN STORAGE DEVICES, and filed on Aug. 27, 2021, the entirety of each of which is hereby incorporated by reference herein, including any figures, tables, drawings, or other information.

### FIELD OF THE DISCLOSURE

This disclosure relates to grain storage devices used in agriculture. More specifically and without limitation, this disclosure relates to a sensor system for grain storage devices such as grain bins.

### OVERVIEW

Grain storage devices are massive structures used to store bulk flowable grain products such as corn, soybeans, wheat, rice, nuts, pistachios, or any other grain or agricultural products or other material. One common form of grain storage devices is what are known as grain bins.

For simplicity purposes, reference is made herein to grain bins as one of countless examples of grain storage devices. However, the disclosure is not intended to be limited to grain bins and instead the disclosure is intended to apply to all grain storage devices. As such, unless specifically stated otherwise, reference to a grain bin is intended to include all forms of grain storage devices.

Similarly, for simplicity purposes, reference is made herein to grain. However, the disclosure is not intended to be limited to grain. Instead the disclosure is intended to apply to corn, soybeans, wheat, rice, nuts, popcorn, pistachios, small grains, large grains, unprocessed grains, processed grains, foodstuffs, unprocessed foodstuffs, processed foodstuffs, other commodities, or any other grain or agricultural products or other flowable material. As such, unless specifically stated otherwise, reference to grain is intended to include all forms of corn, soybeans, wheat, rice, nuts, popcorn, pistachios, small grains, large grains, unprocessed grains, processed grains, foodstuffs, unprocessed foodstuffs, processed foodstuffs, other commodities, or any other grain or agricultural products or other material.

Conventional grain bins are generally formed in a cylindrical shape with a corrugated sidewall covered by a peaked roof formed by a plurality of roof panels. Grain bins vary in height (ranging from twenty feet high to over a hundred and fifty feet high), and diameter (ranging from eighteen feet in diameter to over a hundred and fifty feet in diameter). The storage capacity of modern grain bins can range anywhere from a few thousand bushels to well over a million bushels.

Grain bins are often used to store grain for long periods of time. To ensure the stability of bulk grain during long-term storage the temperature and/or moisture level of the grain is closely monitored and controlled. More grain is damaged by improper storage conditions than any other reason. The most common problems are: inadequate observation of grain during storage (e.g., not checking grain frequently, improper grain management (e.g., not using aeration to control grain temperature), pockets of fines (broken kernels, weed seeds, and debris) that may restrict airflow and/or provide food for insects and mold, grain deteriorating because it was held too long without adequate aeration prior to drying, improper cooling of grain after drying, poor initial grain quality or insufficient drying to safe moisture content, freezing of grain, and/or improper or lack of insect control. To ensure the stability of bulk grain during long-term storage, environmental conditions within a grain bin must be monitored and controlled.

To facilitate monitoring, sensor systems may be installed in grain bins. Some sensor systems position a plurality of sensors along the lengths of cables, which are hung from a roof and/or rafters of the grain bin. These are often custom made for specific lengths based on the height of a particular grain bin. However, it is common to expand capacity of a grain bin from time to time by detaching and lifting the roof and adding one or more rings to increase height of the grain bin. Unfortunately, after expanding capacity sensor cables cannot be easily expanded to facilitate monitoring the entire grain bin.

Therefore, for all the reasons stated above, and the reasons stated below, there is a need in the art for an improved sensor system for grain storage devices.

Thus, it is a primary object of the disclosure to provide a sensor system for grain storage devices that improves upon the state of the art.

Another object of the disclosure is to provide a sensor system that monitors environmental conditions throughout a grain storage device.

Yet another object of the disclosure is to provide a sensor system that permits real-time monitoring of environmental conditions throughout a grain storage device.

Another object of the disclosure is to provide a sensor system having multi-segment sensor cables that can be increased and decreased in length.

Yet another object of the disclosure is to provide a sensor system that permits sensors to be replaced in the field without uninstalling sensor cables.

Another object of the disclosure is to provide a sensor system that is durable.

Yet another object of the disclosure is to provide a sensor system that is easy to manufacture.

Another object of the disclosure is to provide a sensor system that is relatively inexpensive.

Yet another object of the disclosure is to provide a sensor system that has a robust design.

Another object of the disclosure is to provide a sensor system that is high quality.

Yet another object of the disclosure is to provide a sensor system that is easy to install.

Another object of the disclosure is to provide a sensor system that can be installed using conventional equipment and tools.

Yet another object of the disclosure is to provide a sensor system that reduces grain bin corrosion.

Another object of the disclosure is to provide a sensor system that reduces grain spoilage.

Yet another object of the disclosure is to provide a sensor system that can be used with any grain bin.

These and other objects, features, or advantages of the disclosure will become apparent from the specification, figures, and claims.

### SUMMARY OF THE DISCLOSURE

In one or more arrangements, a sensor system for a grain storage device is provided. In one or more arrangements, the sensor system includes sensor cable segments that are configured to connect together in series to form a multi-segment sensor cable. In one or more arrangements, each sensor cable segment has a housing, a sensor circuit, a support cable, and a data cable.

In one or more arrangements, the system includes a roof access port configured to be installed over an opening in a roof of the grain bin that is positioned above the multi-segment sensor cable. In one or more arrangements, the roof access port includes a housing having a hollow interior and a cover. In one or more arrangements, the roof access port includes a first seal between the housing and the roof and a second seal between the housing and the cover.

In one or more arrangements, the system includes a control module positioned in the hollow interior. In one or more arrangements, the control module is communicatively connected to the sensor cable and is configured to receive sensor data from the sensor cable segments. In one or more arrangements, the control module is configured to communicate received sensor data to a data processing system.

In one or more arrangements, the control module is configured to perform a process to determine positions of the sensor circuits of the plurality of sensor cable segments in the multi-segment sensor cable. In one or more arrangements, the process includes transmitting a configuration token to the sensor circuit of an uppermost one of the plurality of sensor cable segments in the multi-segment sensor cable. In one or more arrangements, each of the plurality of sensor cable segments is configured to, in response to receiving the configuration token: communicate a unique identifier of the sensor circuit to the control module forward the configuration token to the sensor circuit of the next one of the plurality of sensor cable segments in the multi-segment sensor cable.

### BRIEF DESCRIPTION OF THE DRAWINGS

FIG. 1 shows an upper cutaway perspective view of an example grain bin having a sensor system, in accordance with one or more arrangements.

FIG. 2 shows an upper cutaway perspective view of an example grain bin having a sensor system, in accordance with one or more arrangements; the view showing close up exploded perspective views of a modular multi-segment sensor cable segment and a roof access port.

FIG. 3. shows an exploded perspective view of a sensor cable segment for use in a modular multi-segment sensor cable, in accordance with one or more arrangements.

FIG. 4. shows a lower front right perspective view of a housing of a sensor cable segment for use in a modular multi-segment sensor cable, in accordance with one or more arrangements.

FIG. 5. shows an upper front right perspective view of a housing of a sensor cable segment for use in a modular multi-segment sensor cable, in accordance with one or more arrangements.

FIG. 6. shows an exploded upper front right perspective view of a housing and sensor circuit of a sensor cable segment for use in a modular multi-segment sensor cable, in accordance with one or more arrangements.

FIG. 7. shows an upper front right perspective view of a cover for a housing of a sensor cable segment for use in a modular multi-segment sensor cable, in accordance with one or more arrangements.

FIG. 8. shows an upper front right perspective view of a support cable for a sensor cable segment for use in a modular multi-segment sensor cable, in accordance with one or more arrangements.

FIG. 9. shows an upper front right perspective view of a sensor cable segment for use in a modular multi-segment sensor cable, in accordance with one or more arrangements.

FIG. 10. shows an upper front right perspective view of a first sensor cable segment for use in a modular multi-segment sensor cable, in accordance with one or more arrangements; the view showing a portion of a second sensor cable segment connected to a lower end of the first sensor cable segment.

FIG. 11. shows a partial left side view of a sensor cable segment and tie down for use in a modular multi-segment sensor cable, in accordance with one or more arrangements; the view showing the tie down positioned to be connected to a lower end of the housing.

FIG. 12. shows a partial upper left front perspective view of a sensor cable segment and tie down for use in a modular multi-segment sensor cable, in accordance with one or more arrangements.

FIG. 13. shows a side view of a sensor cable segment operably connected to a roof of a grain bin, in accordance with one or more arrangements; the view showing the sensor cable segment operably connected to a roof of a grain bin by a hanger bracket assembly.

FIG. 14. shows a front view of a sensor cable segment operably connected to a roof of a grain bin, in accordance with one or more arrangements; the view showing the sensor cable segment operably connected to a roof of a grain bin by a hanger bracket assembly.

FIG. 15. shows a front view of a sensor cable segment, in accordance with one or more arrangements.

FIG. 16. shows a side view of a sensor cable segment, in accordance with one or more arrangements.

FIG. 17. shows an upper, front, left of a sensor cable segment for use in a modular multi-segment sensor cable, in accordance with one or more arrangements.

FIG. 18 shows an exploded left side view of a sensor cable segment for use in a modular multi-segment sensor cable, in accordance with one or more arrangements.

FIG. 19. shows a left side view of a sensor cable segment for use in a modular multi-segment sensor cable, in accordance with one or more arrangements.

FIG. 20. shows a left side view of two sensor cable segments connected in series to form a modular multi-segment sensor cable, in accordance with one or more arrangements.

FIG. 21. shows right side cross sectional view of a housing of a sensor cable segment for use in a modular multi-segment sensor cable, in accordance with one or more arrangements; the view showing the sensor cable segment having a support cable that extends the length of the sensor cable segment; the view showing the sensor cable segment having a data cable connected to an upper end of the housing.

FIG. 22. shows right side cross sectional view of a housing of a sensor cable segment for use in a modular multi-segment sensor cable, in accordance with one or more arrangements; the view showing the sensor cable segment having a support cable that extends the length of the sensor cable segment; the view showing the sensor cable segment having a data cable connected to an upper end of the housing; the view showing a tie down connected to a lower end of modular multi-segment sensor cable.

FIG. 23. shows a left side view of a sensor cable segment for use in a modular multi-segment sensor cable, in accordance with one or more arrangements; the view showing the sensor cable segment having a support cable that extends the length of the sensor cable segment and through the housing.

FIG. 24 shows an exploded left side view of a sensor cable segment for use in a modular multi-segment sensor cable, in accordance with one or more arrangements; the view showing the sensor cable segment having a support cable that extends the length of the sensor cable segment and through the housing.

FIG. 25. shows a front view of an example sensor circuit for use in a sensor cable segment of a modular multi-segment sensor cable, in accordance with one or more arrangements.

FIG. 26 shows a partial lower front view of a sensor cable segment for use in a modular multi-segment sensor cable, in accordance with one or more arrangements.

FIG. 27. shows an upper, front, left of a sensor cable segment for use in a modular multi-segment sensor cable, in accordance with one or more arrangements.

FIG. 28 shows a top cutaway view of a sensor cable segment proximate to the sensor circuit, in accordance with one or more arrangements.

FIG. 29. shows a left side view of two sensor cable segments connected in series to form a modular multi-segment sensor cable, in accordance with one or more arrangements; the view showing the sensor cable segment having a support cable that extends the length of the sensor cable segment and through the housing.

FIG. 30. shows an upper front right perspective view of a housing and sensor circuit of a sensor cable segment for use in a modular multi-segment sensor cable, in accordance with one or more arrangements; the view showing a cover an sensor circuit removed from the housing.

FIG. 31 an upper front right perspective view of the housing and sensor circuit of the sensor cable segment shown in FIG. 30, in accordance with one or more arrangements; the view showing the cover installed on the housing.

FIG. 32 shows an exploded upper front right perspective view of a housing and sensor circuit of a sensor cable segment for use in a modular multi-segment sensor cable, in accordance with one or more arrangements; the view showing a cover an sensor circuit removed from the housing; the view showing two halves of housing separated from one another.

FIG. 33 shows an upper front perspective view of a roof access port, in accordance with one or more arrangements; the view showing a cover rotated to an unlocked position.

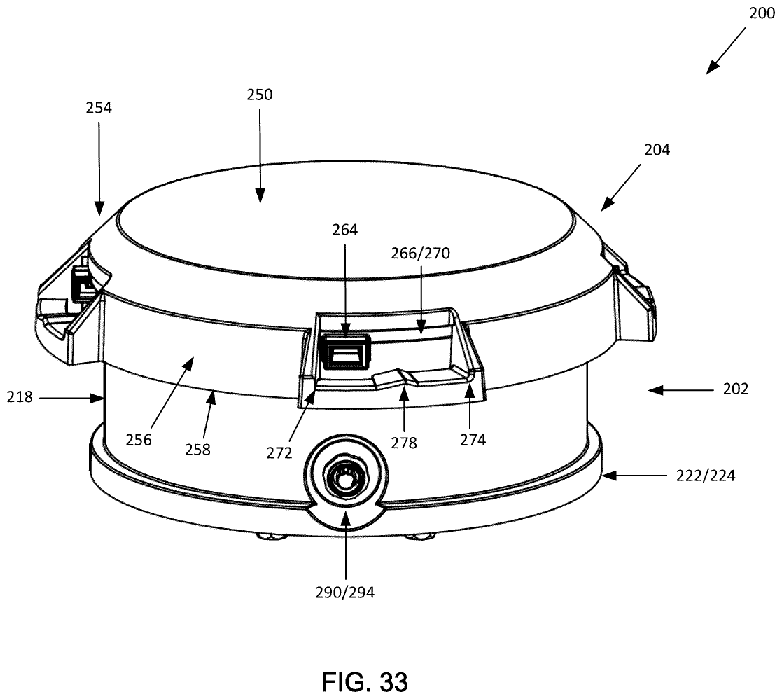

FIG. 34 shows an upper front perspective view of a roof access port, in accordance with one or more arrangements; the view showing a cover rotated to a locked position.

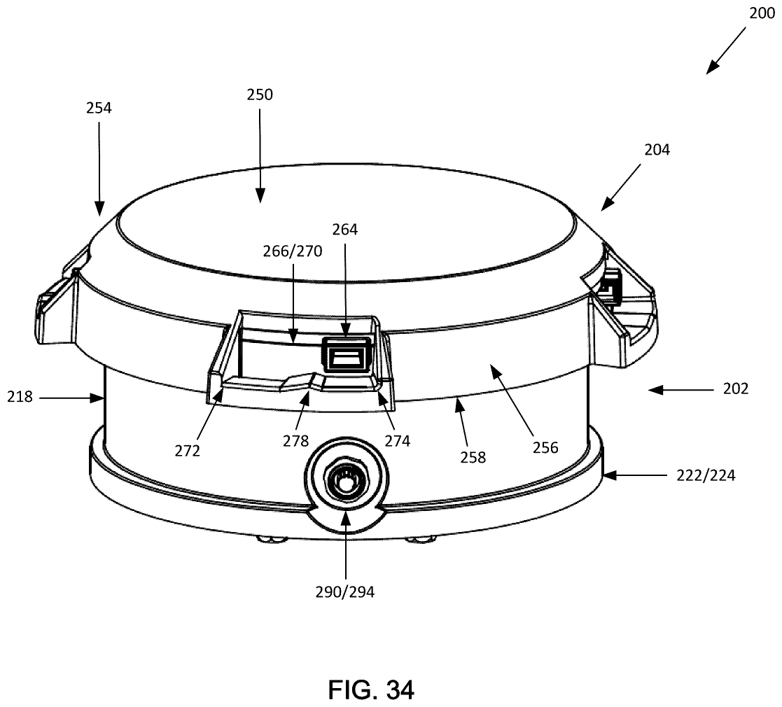

FIG. 35 shows a lower side perspective view of a cover, control module, and data cable for a roof access port, in accordance with one or more arrangements.

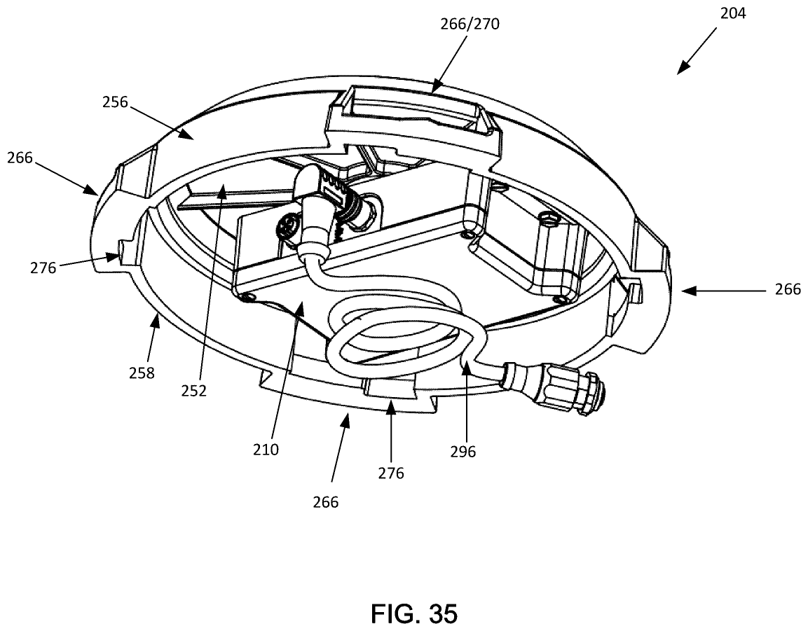

FIG. 36 shows an exploded lower side perspective view of a cover, control module, and data cable for a roof access port, in accordance with one or more arrangements.

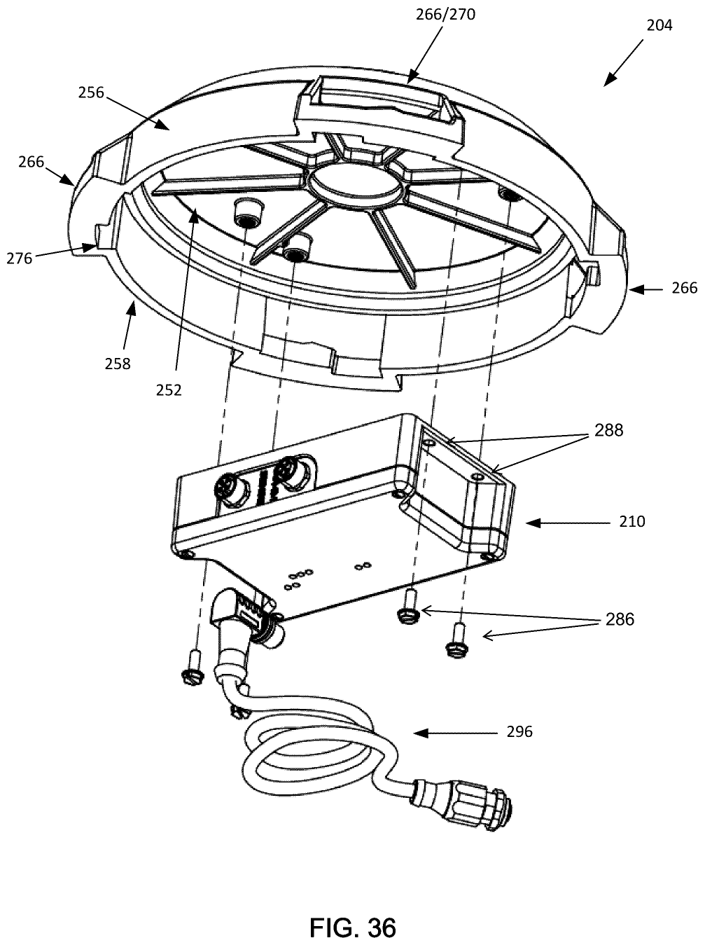

FIG. 37 shows an exploded upper rear left perspective view of a housing and data cable for a roof access port, in accordance with one or more arrangements.

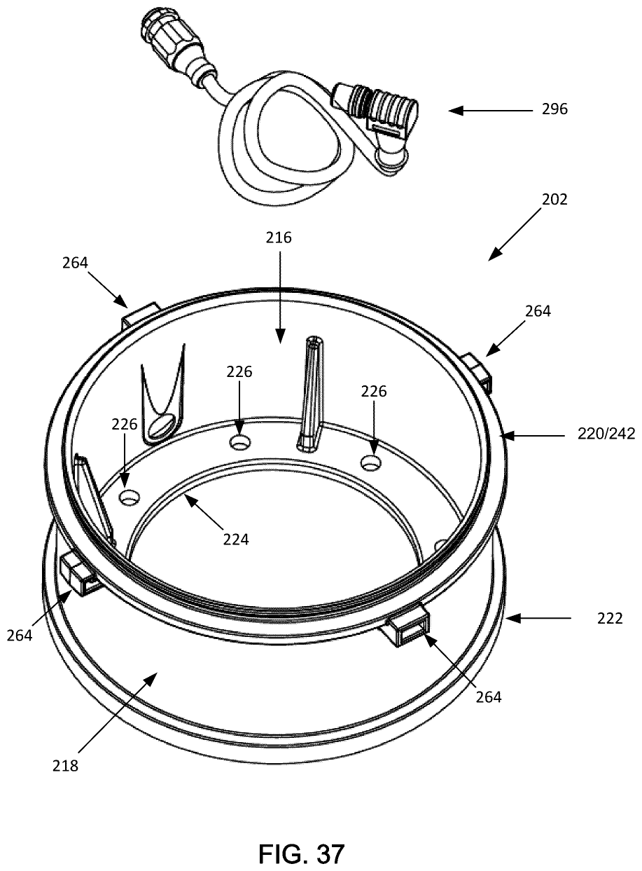

FIG. 38 shows an upper rear left perspective view of a housing and data cable for a roof access port, in accordance with one or more arrangements.

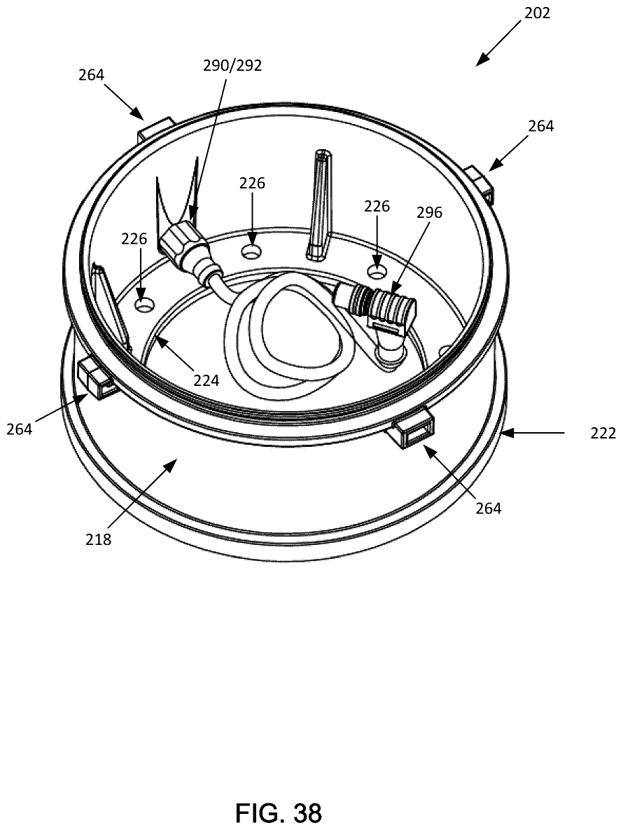

FIG. 39 shows a lower perspective view of a cover and control module for a roof access port, in accordance with one or more arrangements.

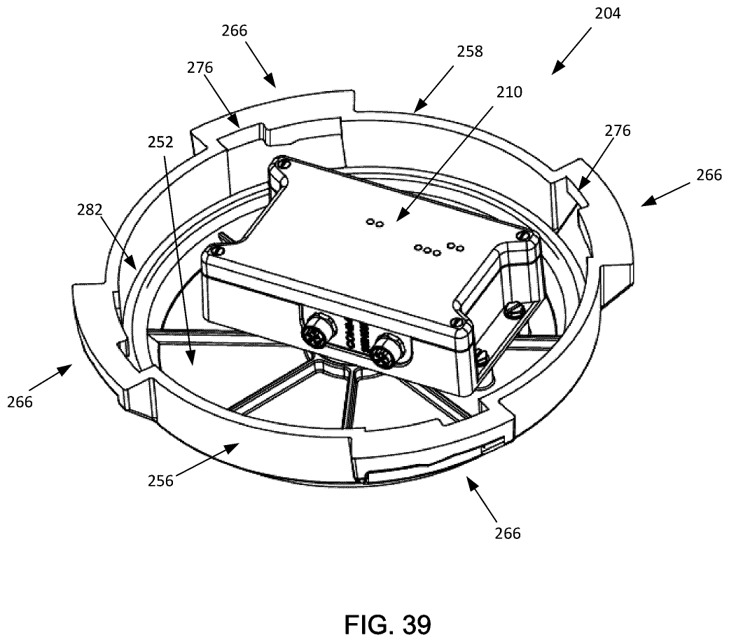

FIG. 40 shows an exploded lower perspective view of a cover and control module for a roof access port, in accordance with one or more arrangements.

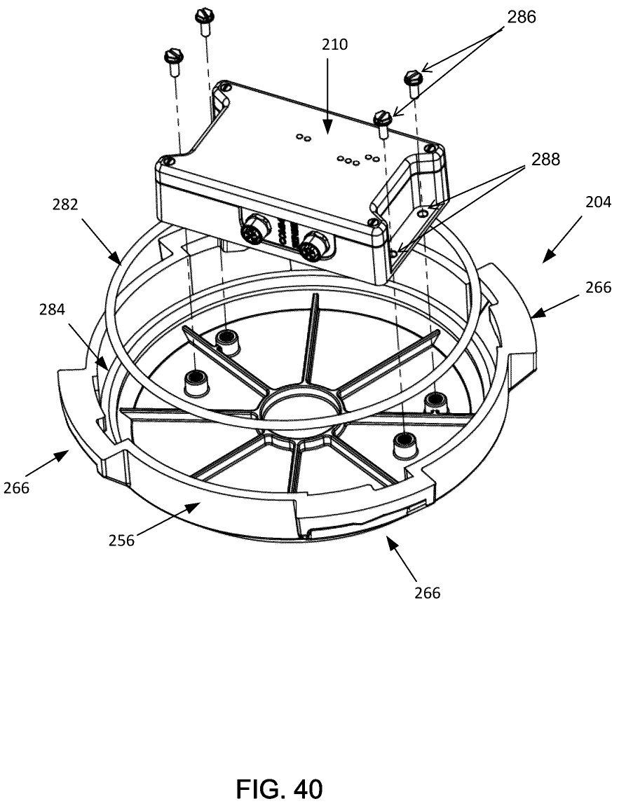

FIG. 41 shows an upper rear perspective view of a roof access port, in accordance with one or more arrangements; the view showing a cover rotated to a locked position.

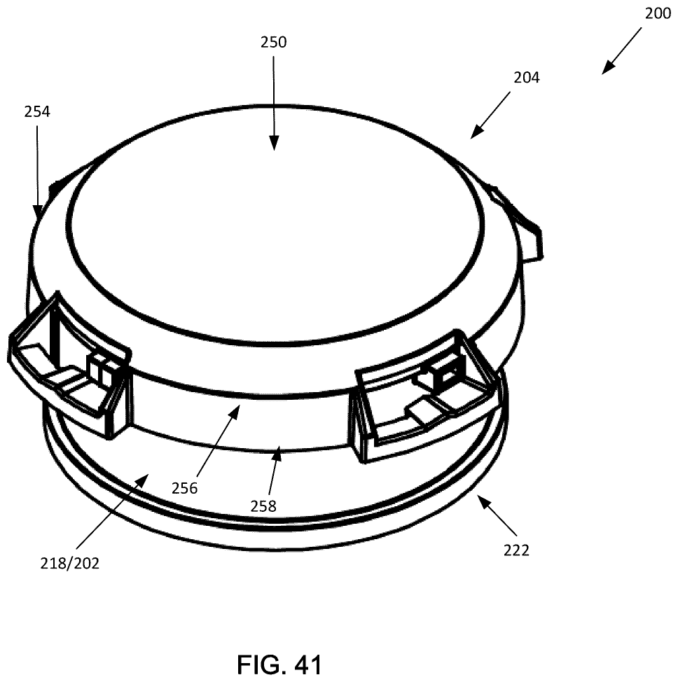

FIG. 42 shows an exploded upper rear left perspective view of a roof access port, in accordance with one or more arrangements.

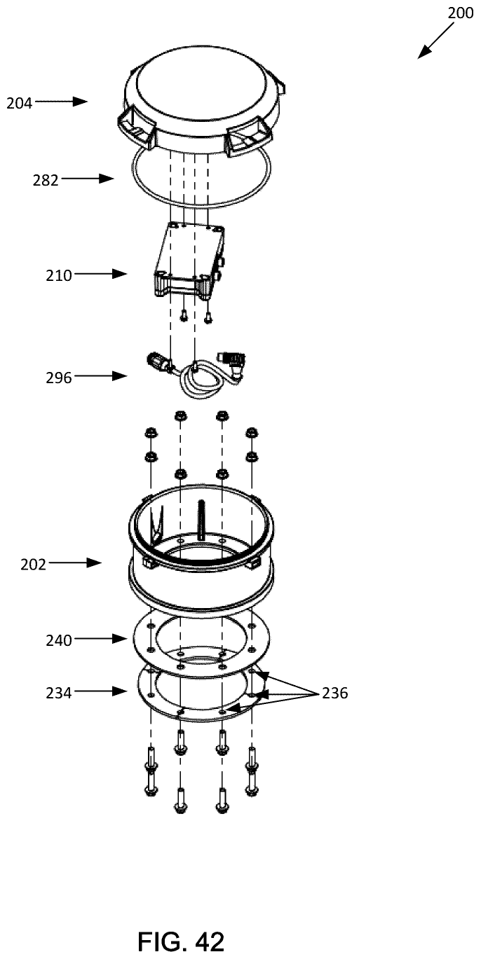

FIG. 43 shows an exploded upper rear left perspective view of a body, sealing member, and plates of a roof access port, in accordance with one or more arrangements.

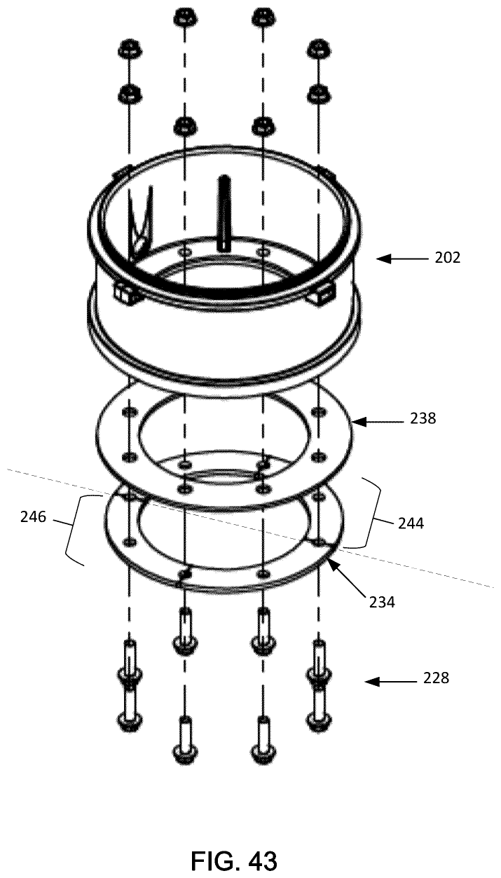

FIG. 44 shows an exploded top view of plates for installation of a roof access port, in accordance with one or more arrangements.

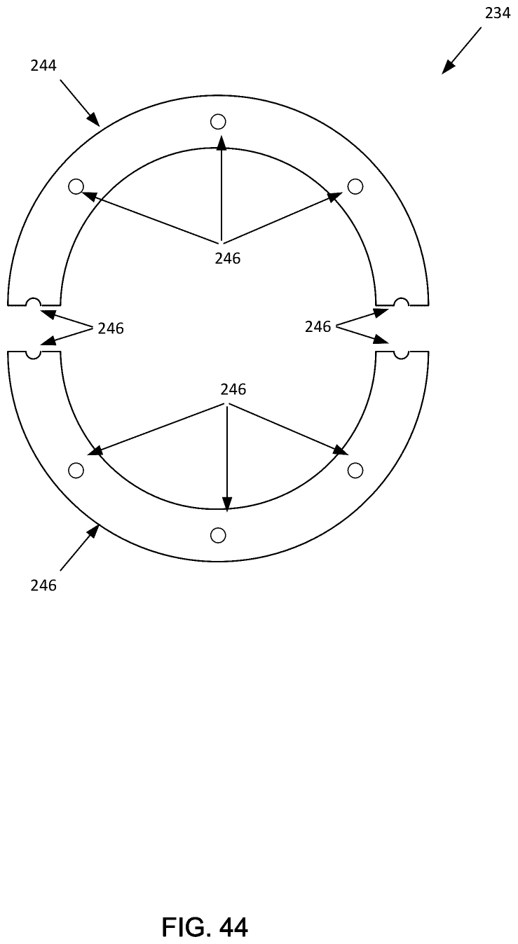

FIG. 45 shows an exploded upper rear left perspective view of a roof access port, in accordance with one or more arrangements; the view showing a sensor module and bracket positioned below the roof access port.

FIG. 46 shows an close up view of the sensor module and bracket shown in FIG. 54.

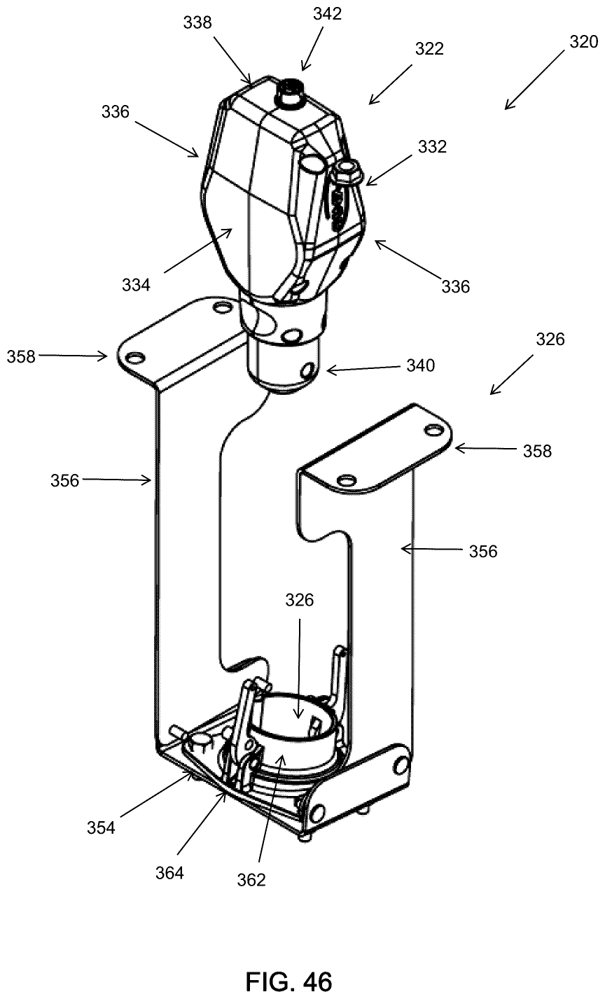

FIG. 47 shows a diagram of a sensor system for a grain bin utilizing modular multi-segment sensor cable, in accordance with one or more arrangements.

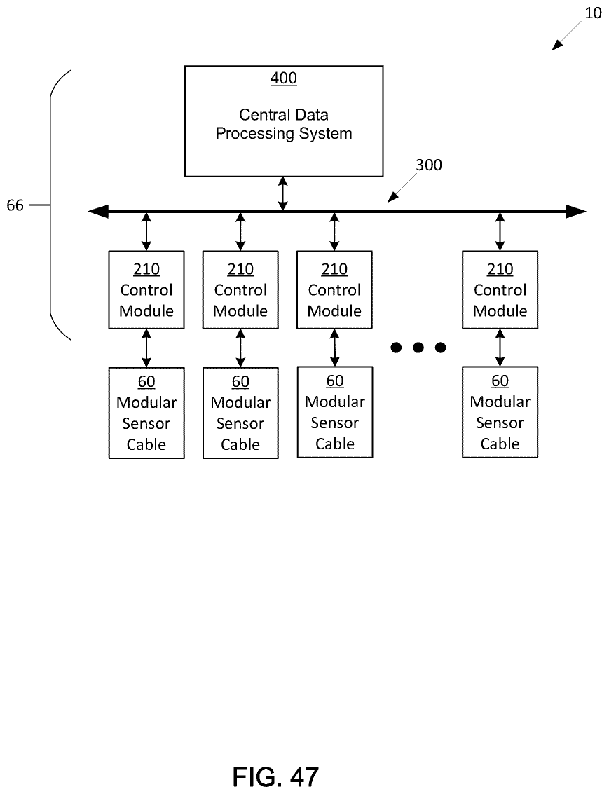

FIG. 48 shows an example control circuit for use in a sensor system for a grain bin, in accordance with one or more arrangements.

FIG. 49 shows a flowchart diagram of an example process for controlling operation of a grain bin in response to sensor data acquired by a sensor system, in accordance with one or more arrangements.

FIG. 50 shows a flowchart diagram of another example process for controlling operation of a grain bin in response to sensor data acquired by a sensor system, in accordance with one or more arrangements.

FIG. 51 shows an example sensor programmer for use with a sensor system for a grain bin, in accordance with one or more arrangements.

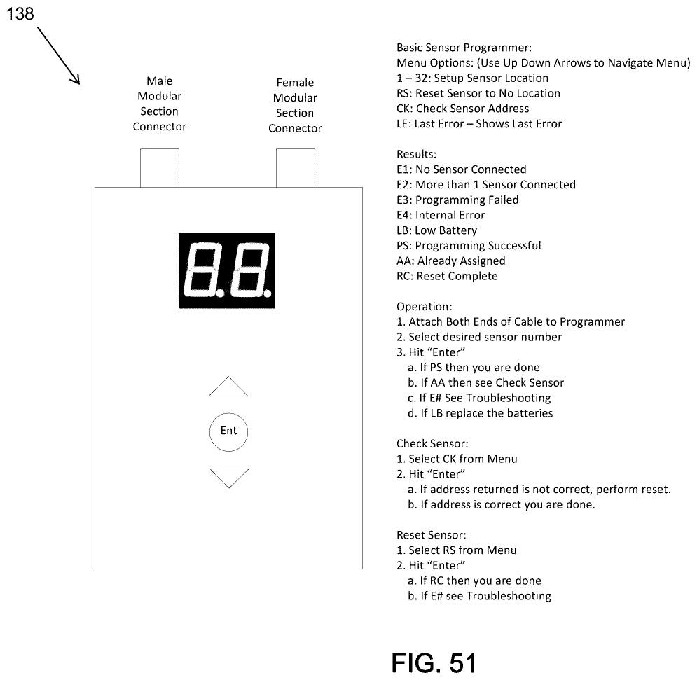

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of window treatments, the embodiments are not so limited. It is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of grain bins. However, the embodiments are not so limited. It is appreciated that the embodiments may be adapted for use in other applications, which may be improved by the disclosed structures, arrangements and/or methods. The system is merely shown and described as being used in the context of grain bins for ease of description and as one of countless example applications.

Turning now to the figures, a multi-segment sensor cable system 10 (or simply system 10) is presented for monitoring agricultural products in a grain bin 12, as is shown as one example.

### Grain Bin 12:

In the arrangement shown, as one example, sensor system 10 is used in association with a grain bin 12. However, it is hereby contemplated that sensor system 10 may be used with any grain storage device and use with grain bin 12 is only one of countless examples. As such, unless stated otherwise, reference to grain bin 12 is intended to imply any grain storage device.

Grain bin 12 may be formed of any suitable size, shape, and design and is configured to hold a bulk amount of flowable material such as grain or the like materials. In one or more arrangements, as is shown, grain bin 12 is a large, generally cylindrical structure that has a curved sidewall 14. Sidewall 14 connects at its lower end to a foundation 16. Sidewall 14 connects at its upper end to a peaked roof 18.

Sidewall 14 of grain bin 12 is formed of any suitable size, shape, and design and is configured to enclose sides of grain bin 12. In one or more arrangements, as is shown, sidewall 14 is formed of a plurality of sheets 20 of material. Sheets 20 have an upper edge 22, a lower edge 24, and side edges 26. Sheets 20 have an exterior surface 28 and an interior surface 30 (not shown). In the arrangement shown, as one example, these sheets 20 are formed of corrugated material. That is, when sheets 20 are viewed from their side edge 26, the sheets 20 have a repetitive oscillating curve that smoothly transitions between rounded peaks and rounded valleys, similar to that of a sine-wave or sine-function. This corrugation provides strength and rigidity to the sheets of material that form sidewall 14. Any other configuration of sidewall 14 and more broadly grain bin 12 or even more broadly a grain storage device, is hereby contemplated for use in association with sensor system 10.

Sheets 20 of sidewall 14 may be formed of a single layer of material. Alternatively, to increase the strength and rigidity of the sidewall 14 a plurality of sheets 20 may be laid over one another, thereby forming what is known as a “laminated” sheet 20 of sidewall 14. Laminated sheets 20 may include two, three, four, five, or any other number of layers.

In one or more arrangements, as is shown, sheets 20 curve slightly from side edge 26 to side edge 26 such that each sheet 20 forms a partial portion of a cylinder. In this example arrangement, a plurality of sheets 20 are connected together in side-to-side arrangement to form what is known as a ring 32. In one or more arrangements, as is shown, rings 32 are vertically stacked to form sidewall 14, which extends from foundation 16 at its lower end to peaked roof 18 at its upper end.

In the arrangement shown, as one example, grain bin 12 includes a roof 18. Roof 18 may be formed of any suitable size, shape, and design and is configured to cover and enclose the upper end of grain bin 12. In the arrangement shown, as one example, roof 18 is formed of a plurality of panels 34. In the arrangement shown, as one example, panels 34 extend a length from an upper end 36 to a lower end 38. In the arrangement shown, as one example, panels 34 extend a width between opposing ribs 40. Each panel 34 may be formed of a single piece of material or multiple pieces of material that are connected to one another.

In the arrangement shown, as one example, upper end 36 of panels 34 connect to or terminate at center ring 42. In the arrangement shown, as one example, center ring 42 is a generally circular shaped member that has a hollow interior that provides a passageway into the hollow interior of grain bin 12 that is used to fill grain bin 12 with grain. The assembly of center ring 48 also facilitates the connection of the upper end 36 of panels 34 to center ring 42, thereby securing the upper end 36 of panels 34. In the arrangement shown, as one example, center ring 42 is positioned at the approximate middle or center of grain bin 12. Any other configuration is hereby contemplated for center ring 42.

In the arrangement shown, as one example, upper end 36 of panels 34 is positioned above lower end 38 of panel 34 so as to facilitate water, dust, dirt, and debris that collects on roof 18 to shed downward and outward away from grain bin 12. In the arrangement shown, as one example, lower end 38 of panels 34 extend past sidewall 14 a distance so as to facilitate water, dust and debris that is shed off of roof 18 clears sidewall 14, thereby keeping sidewall 14 clean and dry.

In the arrangement shown, as one example, upper end 36 of panels 34 are narrower than lower end 38 of panels 34. This arrangement allows a plurality of panels 34 to extend around the center point of roof 18 while extending downward and outward from the center point. In the arrangement shown, as one example, ribs 40 of one panel 34 nest with the ribs 40 of the adjacent panels 34 in an overlapping and nesting condition. In the arrangement shown, as one example, to facilitate this overlapping and nesting condition, ribs 40 are formed of trapezoidal shaped members, or more specifically isosceles trapezoid shaped members, when viewed from the upper end 36 or lower end 38 of panel 34. However, any other shape is hereby contemplated for use as ribs 40.

In the arrangement shown, as one example, panel 34 is generally flat and planar between upper end 36 and lower end 38 and between the interior edges of opposing ribs 40. In the arrangement shown, as one example, ribs 40 add strength and rigidity to panel 34 and roof 18. In addition, ribs 40 provide a convenient, strong, secure and easy-to-install/assemble manner of connecting adjacent panels 34. In the arrangement shown, as one example, when ribs 40 of adjacent panels 34 are nested with one another in overlapping condition, fasteners, such as screws or bolts can be passed through the overlapping ribs 40, thereby securing adjacent panels to one another. In addition, fasteners such as screws or bolts can be passed through portions of roof 18 and into other portions of grain bin 12, thereby securing roof 18 to grain bin 12.

In the arrangement shown, roof 18 includes one or more roof vents 50 positions in panels 34 of roof. Roof vents 50 facilitate may be opened to facilitate movement of air through grain bin 12 or may be closed to seal in the content of grain bin 12.

### Sensor System 10:

Sensor system 10 is formed of any suitable size, shape, and design and is configured to facilitate positioning and gathering data from sensors distributed inside of a grain bin 12. In one or more arrangements, system 10 includes a plurality of multi-segment sensor cable systems 60, hanger bracket assemblies 62, tie downs 64, and a data system 66 communicatively connected to the multi-segment sensor cable systems 60, among other components.

### Multi-Segment Sensor Cable System(s) 60:

Multi-segment sensor cable system 60 is formed of any suitable size, shape, and design and is configured to facilitate connecting a plurality of sensors 122 along an adjustable cable length. In the arrangement shown, multi-segment sensor cable system 60 includes a plurality of sensor cable segments 70 that are configured to be connectable together in a daisy chain configuration and facilitate length adjustment of the multi-segment sensor cable system 60 by adding or removing sensor cable segments 70 from the daisy chain. In the arrangement shown, as one example, multi-segment sensor cable system 60 includes a respective sensor cable segment 70 for each ring 32 of grain bin 12 to facilitate monitoring of grain in each ring 32. However, the embodiments are not so limited. Rather, it is contemplated that in one or more arrangements multi-segment sensor cable system 60 may include any number of sensor cable segments 70, which may have any length, and/or which may have more or fewer number of sensors 122.

### Sensor Cable Segments 70

Sensor cable segments 70 are formed of any suitable size, shape, and design and are configured to facilitate connecting the sensor cable segments 70 together in a daisy chain to facilitate positioning a plurality of sensors 122 along a length of multi-segment sensor cable system 60 and communication of data from the plurality of sensors to data system 66. In the arrangement shown, as one example, each sensor cable segment 70 has a housing 74, a sensor circuit 76, a support cable 78, and a data cable 80, among other components.

### Housing 74:

Housing 74 is formed of any suitable size, shape, and design and is configured to house a sensor circuit 76, operably connect with support cable 78, facilitate connection of data cable 80 with sensor circuit 76, and facilitate the ability to operably connect support cable 78 of another sensor cable segment 70. In one or more arrangements shown, as one example, housing 74 has an elongated rectangular shape having a front 86, a back 88, and opposing sides 90 extending from an upper end 92 to a lower end 94. In this example arrangement, housing 74 has a recess 100 in the front 86 to receive and hold sensor circuit 76 therein. In this example arrangement, housing 74 has elongated channels 102 extending upward and downward from recess 100 to accommodate and facilitate connection of data cables 80 with sensor circuit 76.

In various arrangements, housing may be fabricated using various different methods and/or means including but not limited to, for example, milling/machining, cutting, casting, forging, stamping, welding, extruding, and/or any other means or method for fabrication. As one example, in one or more arrangements, housing may be formed by stamping a rectangular piece of sheet metal into a U or taco shape to form housing 74. Such stamp fabrication may help to reduce manufacturing time and costs while providing a strong housing configured to aid in support of the multi-segment sensor cable 70. However, the arrangements are not so limited. Rather, it is contemplated that in various arrangements, housing 74 may be formed of various materials including but not limited to, for example, metallic materials (e.g., aluminum, steel, iron, brass, copper, lead, tin, magnesium, zinc, pewter, titanium, or any other metallic material or alloy or the like), polymer plastics (e.g., acrylic, ABS, Nylon, PLA, Polybenzimidazole, polycarbonate, polyether sulfone, polyoxymethylene, polyetherimide, polyethylene, polyethylene oxide, polyethylene sulfide, polypropylene, polystyrene, polyamide, polypropylene, alkyd, silicon resins, polyvinyl chloride, polyvinylidene fluoride, Teflon, acrylic, epoxy, polyurethane, polyamide, polycarbonate, polypropylene, alkyd, and/or silicon resins), natural materials (e.g., wood and/or textiles) and/or composite materials.

### Covers 104:

In one or more arrangements, housing 74 has covers 104. Covers 104 are formed of any suitable size, shape, and design and are configured to connect with housing 74 and cover sensor circuit 76 in recess 100 and data cables 80 in channels 102. In the arrangement shown, as one example, covers 104 are shaped to fit within recess 100 and/or channels 102.

In this example arrangement, covers 104 have connection features 108 around edges of the covers 104 that engage connection features 110 of the housing 74 to connect covers 104 with housing 74. In this example arrangements, connection features 108 of covers are protrusions that engage holes in housing 74 that form connection features 110. However, the embodiments are not so limited. Rather, it is contemplated that in some various different arrangements, covers 104 may connect with housing 74 using various means and methods known in the art including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof.

### Upper Connection Feature 112 and Lower Connection Feature 114:

In this example arrangement, housing 74 has an upper connection feature 112 to facilitate connection of upper end 92 of housing 74 with a lower end 144 of support cable 78. In this example arrangement, housing 74 also has a lower connection feature 114 to facilitate connecting lower end 94 of housing 74 with an upper end of a support cable 78 of another sensor cable segment 70 to facilitate connecting the segments together in a daisy chain.

In the arrangement shown, upper connection feature 112 and lower connection feature 114 of housing 74 are threaded holes configured to receive and engage threaded termination connectors 146 of support cable 78 to operably connect housing with support cable(s) 78. However, the embodiments are not so limited. Rather, it is contemplated that in some various different arrangements, upper connection feature 112 and lower connection feature 114 of housing 74 may connect with termination connectors 146 of support cable 78 using various means and methods known in the art including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof.

When multiple sensor cable segments 70 of multi-segment sensor cable 60 are connected together in a daisy chain and hung in a grain bin 12, the weight of sensor cable segments 70 is supported entirely by the connected support cables 78 and housings 74 of the multi-segment sensor cable 60. This arrangement may help prevent weight of sensor cable segments 70 from applying stress upon the data cables 80 and sensor circuits 76, which could lead to damage. This arrangement also permits a damaged sensor circuit 76 in one of the sensor cable segments 70 to be removed for repair and/or replacement while keeping the sensor cable segments 70 connected together.

### Sensor Circuit 76:

Sensor circuit 76 is formed of any suitable size, shape, and design and is configured to acquire data from one or more sensors and communicate the acquired data, and data received from other sensor cable segments 70, via data cable 80. In one or more arrangements, as one example, sensor circuit 76 includes a printed circuit board (PCB) 120, one or more sensors 122, a processing circuit 124, an upper electrical connector 126, and a lower electrical connector 128, among other components.

### Printed Circuit Board 120:

PCB 120 is formed of any suitable size, shape, and design and is configured to interconnect and support sensors 122, processing circuit 124, upper electrical connector 126, and/or lower electrical connector 126 of sensor circuit 76. In the arrangement shown, as one example, PCB 120 has an elongated generally rectangular shape extending from an upper end 132 to a lower end 134. In this example arrangement, upper electrical connector 126 is operably connected to upper end 132 of PCB 120 and lower electrical connector 126 is operably connected to lower end 134 of PCB 120.

### Sensors 122:

Sensors 122 are formed of any suitable size, shape, and design, and are configured to measure various environmental or other aspects that may affect storage, conditioning, and/or treatment of contents of grain bin 12. In some various arrangements, sensors 122 may include but are not limited to, for example, temperature sensors, humidity sensors, moisture sensors, chemical sensors, optical sensors, motion sensors, sound or vibration sensors, pressure sensors, RF sensors, and/or any other type of sensor. In some arrangements, sensors 122 may be formed along with processing circuit 124 as a single combined integrated circuit. Alternatively, in some arrangements, sensors 122 and processing circuit 124 may be separate components that are communicatively connected together.

### Processing Circuit 124:

Processing circuit 124 is formed of any suitable size, shape, and design, and is configured to communicatively connect with sensor(s) 122 of sensor circuit 76, upper electrical connector 126, and lower electrical connector 128 and facilitate communication of sensor data along the chain of connected sensor cable segments 70. In the arrangement shown, as one example, processing circuit 124 is configured to communicate measurement data acquired from sensor(s) 122, and data received from other sensor cable segments via lower electrical connector 128, upward along multi-segment sensor cable 60 via data cable 80 connected to upper electrical connector 126. However, the embodiments are not so limited. Rather, it is contemplated that in various different arrangements, processing circuits 124 of sensor cable segments 70 may be configured to communicate data upward along multi-segment sensor cable 60, communicate data upward along multi-segment sensor cable 60, and/or communicate data both upward and downward along multi-segment sensor cable 60.

Although the arrangements are primarily described with reference to sensor cable segments 70 being connected in a daisy chain network topology, the embodiments are not so limited. Rather, it is contemplated that in some various different arrangements, sensor cable segments 70 and/or multi-segment sensor cables 60 may be connected to communicate data in any type of network topology including but not limited to, for example, daisy-chain, data bus, ring, tree, mesh, star, hybrid, ad-hoc, and/or any other network topology.

Moreover, while the arrangements are primarily described with reference to wired communication, cable segments 70 over data cables 80 along multi-segment sensor cable 60, the embodiments are not so limited. Rather, it is contemplated that in one or more arrangements, processing circuits 124 of sensor circuits 76 may be configured to communicate sensor data wirelessly. It is also contemplated that in some various different arrangements, processing circuits 124 of sensor circuits 76 may be configured to communicate data over data cables 80 along multi-segment sensor cable 60 (or wirelessly) using various communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, Modbus, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, FM/VHF/UHF networks, and/or any other communication protocol, technology or network. Likewise, it is also contemplated that in some various different arrangements, processing circuits 124 of sensor circuits 76 may be configured to communicate data over data cables 80 along multi-segment sensor cable 60 (or wirelessly using various access control methods including but not limited to, for example, polling (e.g., by a designated master sensor cable segments 70), token passing, contention based access control (e.g., Carrier Sense Multiple Access with Collision Avoidance and Carrier Sense Multiple Access with Collision Detection), and/or any other method or means for controlling access to a transmission medium.

Processing circuit 124 may be any suitable circuit configured for implementing these operations/activities, as shown in the figures and/or described in the specification including but not limited to, for example, discrete logic circuits and/or programmable circuits. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from a memory. Such memory may be any form of information storage such as flash memory, ram memory, dram memory, a hard drive, or any other form of memory.

In one or more arrangements, processing circuit 124 of sensor circuit 76 is configured to communicate sensor data using a format, protocol, and/or method that permits the identity and/or position of the sensor circuit 76 containing the sensor 122 that generated the data to be determined. For instance, in some arrangements, data system 66 may determine identity and/or position of sensors to facilitate interpretation of the sensor data (e.g., creating a 3D map of sensor readings).

As one example, in one or more arrangements, sensor circuits 76 may be programmed to communicate data in assigned frequencies and/or time slots so as to permit data system 66 to determine which sensor circuit 76 generated the data.

As another example, in one or more arrangements, each sensor circuit 76 may be configured to append its data to the end of data received from the lower sensor cable segment 70. Data system 66 may then determine which sensor generated which data from the order of the sensor readings in the data.

As yet another example, in one or more arrangements, data from each sensor circuit 76 may be communicated in a respective packet having header information that can be used to identify which sensor circuit 76 generated the data. For instance, in some implementations, such header information may include a unique identifier (e.g., a MAC address or other identifier) assigned to the sensor circuit 76 when manufactured. When installing sensor circuits 76 and/or connecting sensor cable segments 70 to form a multi-segment sensor cable 60, the unique identifier of each sensor circuit 76 may be recorded and input to data system 66 for later use to facilitate interpretation of the data.

### Manual Programing of Sensor Circuits:

In some implementations, sensor circuits 76 may be programmed to store information indicating the position of the corresponding sensor cable segment 70 in the multi-segment sensor cable 60 when installing sensor circuits 76 and/or connecting sensor cable segments 70 to form a multi-segment sensor cable 60. Additionally or alternatively, in some implementations, sensor circuits 76 may be programmed to store information to indicate which multi-segment sensor cable 60 the sensor circuit 76 is located. The programmed information of each sensor circuit 76 may be recorded and input to data system 66 for later use to facilitate interpretation of the data.

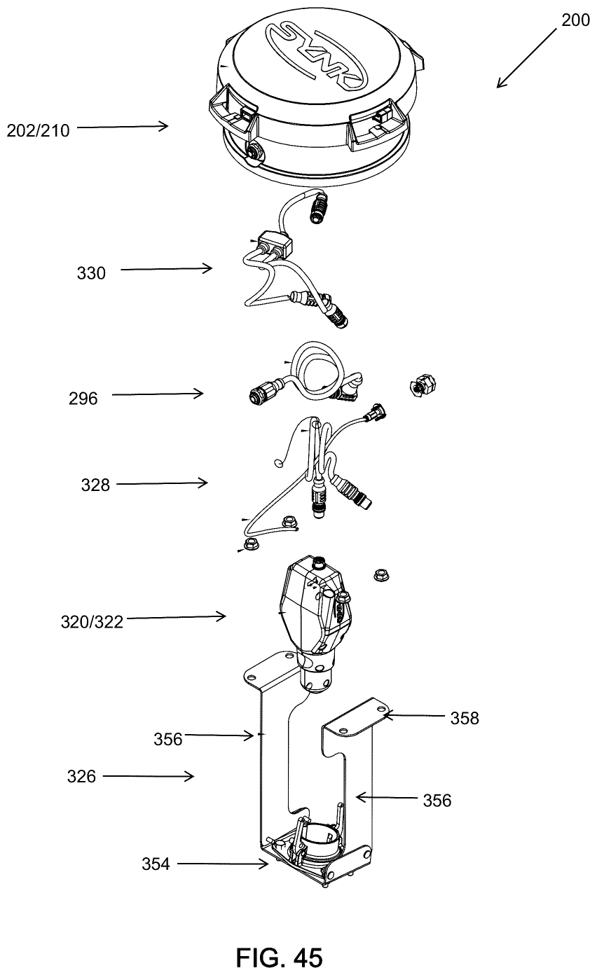

As an illustrative example, FIG. 45 shows an example sensor programmer 138 that may be used to manually program sensor circuits 76 in accordance with one or more arrangements. In this illustrative example, the sensor programmer 138 is configured to be connected to end(s) of multi-segment sensor cable 60 to facilitate assignment of identifiers and/or further configuration of sensor circuits 76 after identifiers are assigned. In this example arrangement, sensor programmer 138 is configured to assign a position identifier to a single unassigned sensor circuit 76 present on the multi-segment sensor cable 60 at a time.

As an example process, data cables 80 at ends of multi-segment sensor cable 60 are connected to programmer 138. Then starting at a first sensor cable segment 70 at one end of multi-segment sensor cable 60:
1) Install sensor circuit 76 in the housing 74 of the sensor cable segment 70.
2) Connect electrical connectors 154 of adjacent data cables 80 to electrical connectors 126/128 of the sensor circuit 76.
3) Enter desired sensor number to indicate the position of the sensor circuit 76 and hit enter.
4) If display reads PS, programming was successful. Move to next sensor cable segment 70 and do back to steps 1-4 until sensor circuits 76 for all sensor cable segment 70 are programmed.

However, the embodiments are not limited to these illustrative examples. Rather, it is contemplated that in some various arrangements, sensor circuit 76 may utilize any format, protocol, and/or method that permits the identity and/or position of the sensor circuit 76 containing the sensor 122 that generated the data to be determined.

### Automated Determination of Sensor Positions:

In one or more arrangements, programmer 138, control module 210, or other device connected to an end of multi-segment sensor cable 60 is configured to automatically determine sensor positions so as to permit control module 210, or other device connected to an end of multi-segment sensor cable 60, and facilitate assignment of identifiers and/or further configuration of sensor circuits 76.

In one or more arrangements, control module 210 is configured to perform an automated process to detect sensors and determine sensor positions upon boot up or reset. As an example process, upon bootup of control module 210:
1) control module 210 sends a transmits a configuration token down the multi-segment sensor cable 60.
2) Upon receipt of the configuration token by a sensor cable segment 70:
   a. The sensor circuit 76 retrieves a unique identifier (e.g., a MAC address or other identifier) assigned to the sensor circuit 76 from a non-volatile memory.
   b. The sensor circuit 76 sends to the control module 210 a configuration response, which indicates the unique identifier of the sensor circuit 76. The configuration response prompts the control module 210 to associate the specified unique identifier as corresponding to the next sensor cable segment 70 in the multi-segment sensor cable 60.
   c. After transmitting the configuration response, the sensor circuit 76 forwards the configuration token to the next sensor cable segment 70 in the multi-segment sensor cable 60.

The process repeats step 2 in this manner until all sensor circuits 76 of cable segment 70 have communicated a configuration response to the control module 210. In this example arrangement, the order in which configuration responses are received by the control module 210 directly corresponds to the order of the sensor circuits of cable segment 70 in the multi-segment sensor cable 60.

In this example process, sensor positions are identified and maintained by control module 210. Additionally or alternatively, in some arrangements, positions may be determined and maintained by sensor circuits 76 of the sensor circuits 76 of cable segments 70. For example, in one or more arrangements, the configuration token may be communicated from control module 210 with a position value initially set to a value of 1. Upon receipt of the configuration token by a sensor circuit 76, the sensor circuit may set its position value to 1 and increment the position value in configuration token before forwarding to the next sensor cable segment 70 in the multi-segment sensor cable 60. In this manner, the process automatically configures the sensor circuits 76 with their respective positions. In one or more arrangements, data from each sensor circuit 76 may thereafter be communicated in a respective packet having information that indicates the position of the sensor.

### Support Cable 78:

Support cable 78 is formed of any suitable size, shape, and design and is configured to operably connect with and suspend housing 74, and any sensor cable segments 70 suspended from housing 74, from a structure that is operably connected to an upper end 142 of support cable 78. In the arrangement shown, as one example, support cable 78 is a flexible steel cable type support structure extending from an upper end 142 to a lower end 144 with termination connectors 146 attached to the upper end 142 and the lower end 144. However, the embodiments are not so limited. Rather, it is contemplated that in some various different arrangements, support cable 78 may be implemented using various different support structures including but not limited to, for example, cables, cords, chains, ropes, wires, straps, belts, rods, bars, and/or any other method or means for suspending objects.

### Termination Connectors 146:

Termination connectors 146 are formed of any suitable size, shape, and design and are configured to facilitate connection of lower end 144 of support cable with upper connection feature 112 and facilitate connection with lower connection feature 114 of another sensor cable segment 70 and/or hanger bracket assemblies 62. In the arrangement shown, as one example, termination connectors 146 are threaded posts. However, the embodiments are not so limited. Rather, it is contemplated that in some various different arrangements, termination connectors 146 may be implemented using various different types of connectors including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof.

### Data Cable 80:

Data cable 80 is formed of any suitable size, shape, and design and is configured to facilitate transmission of data along the multi-segment sensor cable 60. In the arrangement shown, as one example, data cable 80 is a flexible data cable extending from an upper end 150 to a lower end 152 with electrical connectors 154 attached to the upper end 150 and the lower end 152 of the data cable 80. In various different arrangements, data cable 80 may be implemented using various different types of shielded and/or unshielded data cables including but not limited to, for example, twisted pair (e.g., CAT1/CAT2/CAT3/CAT4/CAT5/CAT6/CAT7), ribbon cables, parallel wire, ladder line, coax, fiber optic, serial cables, USB cable, firewire cable, and/or any other type of cable for data transmission.

### Electrical Connectors 126, 128, and 154:

Electrical connectors 126 and 128 of sensor circuit 76 and electrical connectors 154 of data cable 80 are formed of any suitable size, shape, or design, and are configured to electrically connect data cables 80 of with sensor circuits 76 in the multi-segment sensor cable 60. In the arrangement shown, as one example, electrical connectors 126 and 128 of sensor circuit 76 are electrically connected to sensor circuit 76 by short cable segments 130. In this example arrangement, the short cable segments 130 may make it easier to connect electrical connectors 126 and 128 of sensor circuit 76 with electrical connectors 154 of data cable 80 when deployed in the field. However, the embodiments are not so limited. Rather, it is contemplated that in one or more embodiments, electrical connectors 126 and 128 of sensor circuit 76 may be mounted on PCB 120, housing 74, and/or other component(s) of sensor cable segment 70.

In various different arrangements, electrical connectors 126, 128, and 154 may be implemented using various different types of cable connectors including but not limited to, for example, DIN style connectors, Mini DIN style connectors, DB style connectors, 0.050 style connectors, VHDCI style connectors, Centronics style connectors, Mini Centronics style connectors, RJ style connectors, BNC style connectors, USB style connectors, FIREWIRE style connectors, Thunderbolt style connectors, DVI style connectors, mini DVI style connectors, HDMI DVI style connectors, fiber optic style connectors, coaxial style connectors, token ring style connectors, banana plug style connectors, spade style connectors, ring style connectors, XLR style connectors, other audio and/or video style connectors, power cord style connectors, and/or any other type of connector.

### Hanger Bracket Assemblies 62:

Hanger bracket assemblies 62 are formed of any suitable size, shape, and design and are configured to operably connect upper end 142 of support cable 78 of a top sensor cable segment 70 of multi-segment sensor cable 60 to an elevated structure of grain bin 12. In some arrangements, as is shown, hanger bracket assemblies 62 are configured to facilitate adjustment to the height at which the support cable is attached to hanger bracket assemblies 62. Such height adjustment may be useful, for example, when hanger bracket assemblies 62 are connected to the interior of a self supporting roof 18 of grain bin 12 (e.g., ribs 40 of a panel 34 of roof 18), in order to position a set of multi-segment sensor cables all the same height. In the arrangement shown, hanger bracket assemblies 62 include a bracket 160, a vertical member 162, and a fastener 164, among other components.

### Bracket 160:

Bracket 160 is formed of any suitable size, shape, and design and is configured to operably connect vertical member 162 to an elevated mounting point of grain bin 12. In the arrangement shown, as one example, bracket 160 has an elongated generally rectangular shape extending between opposing ends 168, where bracket connects with ribs 40 of a panel 34 of roof 18. In some various different arrangements, bracket 160 may be connected to mounting point(s) of grain bin 12 using various means and methods known in the art including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof. Alternatively, in some arrangements, vertical member 162 may be connected directly to grain bin 12 and bracket 160 omitted.

### Vertical Member 162:

Vertical member 162 is formed of any suitable size, shape, and design and is configured to provide a plurality of positions at a plurality of different heights at which a top sensor cable segment 70 of multi-segment sensor cable 60 may be connected. In the arrangement shown, as one example, vertical member 162 has an elongated generally rectangular shape extending downward from an upper end 172, where vertical member 162 is connected to bracket 160, to a lower end 174. In this example arrangement, vertical member 162 has a plurality of holes 176 extending through vertical member 162 to facilitate attachment of sensor cable segment 70 by fastener 164.

### Fastener 164:

Fastener 164 is formed of any suitable size, shape, and design and is configured to connect support cable 78 of sensor cable segment 70 to vertical member 162. In some various different arrangements, fastener 164 may be any fastening means or method known in the art including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like, or combinations thereof.

### Tie Downs 64:

In some applications, it is desirable to secure a lower end of multi-segment sensor cable 60 in grain bin 12 in order to ensure that movement of grain when filling grain bin 12 does not move sensors 122 to different positions than intended. However, securing multi-segment sensor cables 60 can be difficult for many grain bins 12 that utilize sweep systems to facilitate removal of grain. An exemplary sweep system is described in U.S. Patent Application Publication 2021/0051856, titled SWEEP SYSTEM FOR FULL ELEVATED FLOOR GRAIN BINS, and published Feb. 25, 2021, which is hereby incorporated by reference herein. As described therein, when a sweep system is operated, the sweep system is rotated around the floor of a grain bin 12, which helps move grain to one or more points where grain is removed from the grain bin 12. In one or more arrangements, system 10 includes tie downs to connect a lower end of multi-segment sensor cables 60 (approximately 36 inches above a floor of the grain bin) to the floor using fishing line or other suitable material that will break away when a sweep is operated and permit to rotate unencumbered.

Tie downs 64 are formed of any suitable size, shape, and design and are configured to connect to lower connection feature 114 of housing 74 and facilitate securing tie downs 64 to a floor of grain bin (e.g., using fishing line). In the arrangement shown, as one example, tie downs 64 each include a connector 180 and a tie feature 182.

### Connector 180:

Connector 180 is similar to upper connection feature 112 and may be formed of any suitable size, shape, and design and is configured to facilitate connection of tie down 64 with lower connection feature 114 housing 74 of the lowered sensor cable segment 70 of a multi-segment sensor cable 60. In the arrangement shown, as one example, connector 180 is a threaded post. However, the embodiments are not so limited. Rather, it is contemplated that in some various different arrangements, connector 180 may be implemented using various different types of connectors including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof.

### Tie Feature 182:

Tie feature 182 is formed of any suitable size, shape, and design and is configured to facilitate securing tie downs 64 to a floor of grain bin (e.g., using fishing line). In the arrangement shown, tie feature 182 has an eye shape through which fishing line may be threaded on tied on. However, the embodiments are not so limited. Rather, it is contemplated that in some various different arrangements, tie feature 182 may be implemented using various different types of features including but not limited to, eyes, heads, hooks, cleats, loops, straps, links, loops, sockets, threads, screws, bolts, buttons, clips, clamps, grips, saddles, ferrules, tucks, interconnects, friction fittings, clips, pins, clamps, other coupling devices, adhesives, chemical bonding, or the like or combinations thereof.

### Dummy Load 188:

In one or more arrangements, system 10 includes a dummy load 188 (not shown) configured to connect to lower electrical connector 128 of sensor circuit 76 of the lowest sensor cable segment 70 of multi-segment sensor cable 60. Dummy load 188 is formed of any suitable size, shape, and design and is configured to adjust impedance at lower electrical connector 128 of sensor circuit 76 to improve characteristics for transmission of data by sensor circuit 76 of the lowest sensor cable segment 70.

### ALTERNATIVE ARRANGEMENT

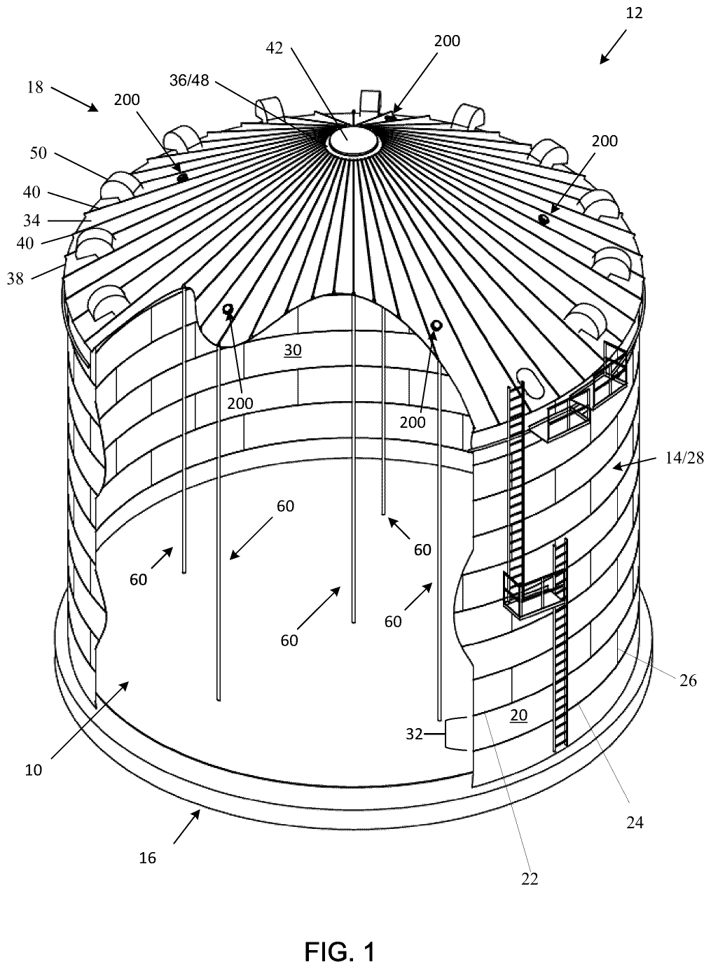

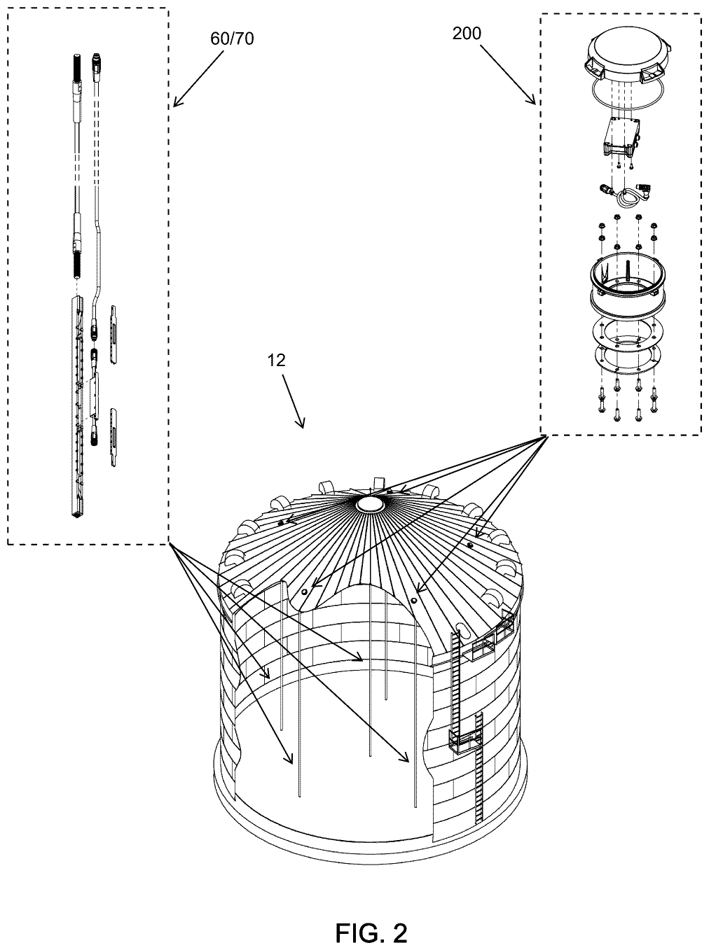

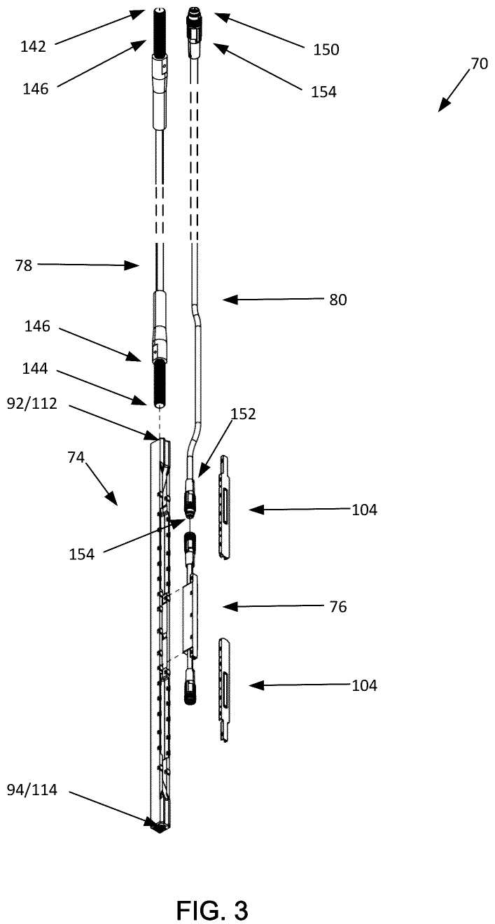

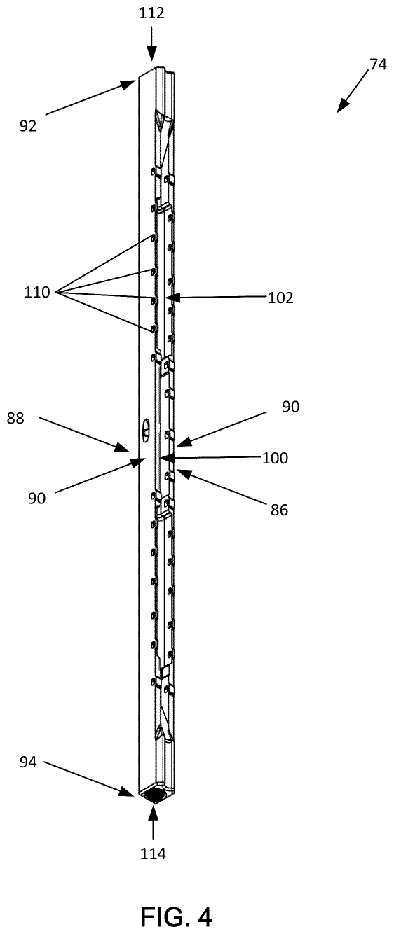

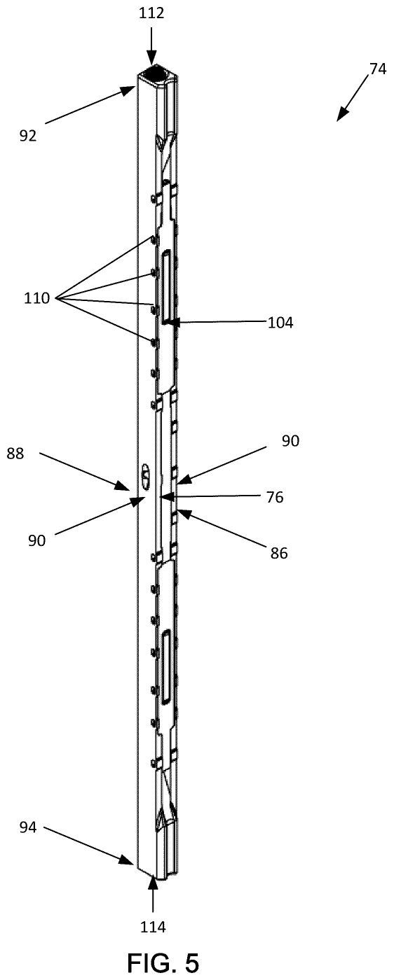

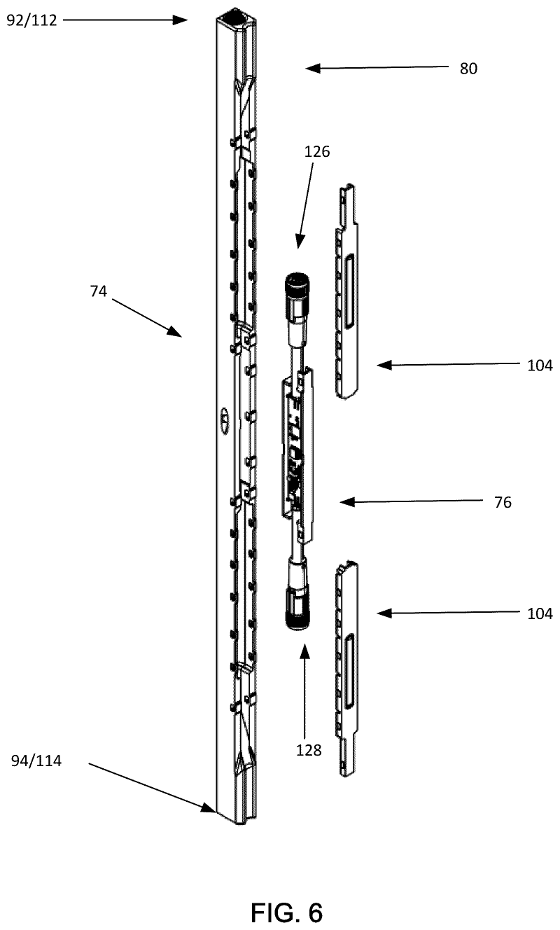

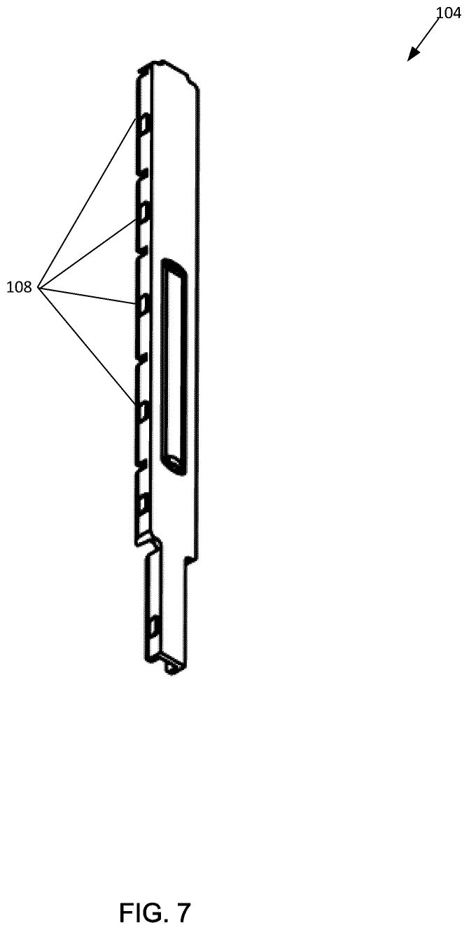

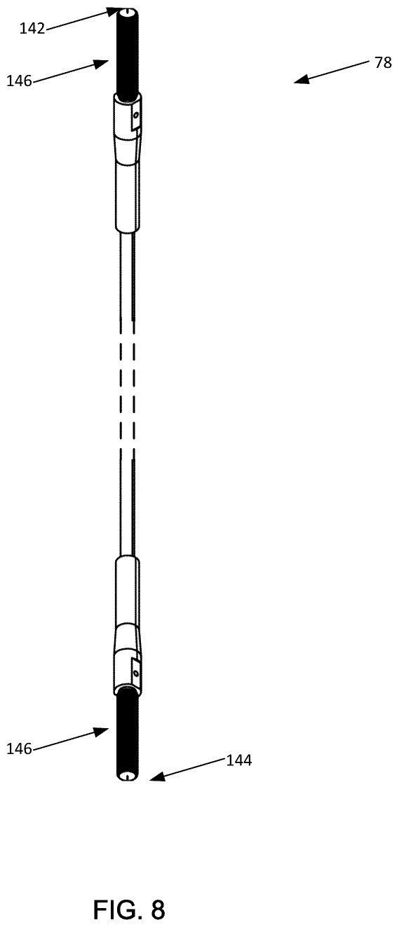

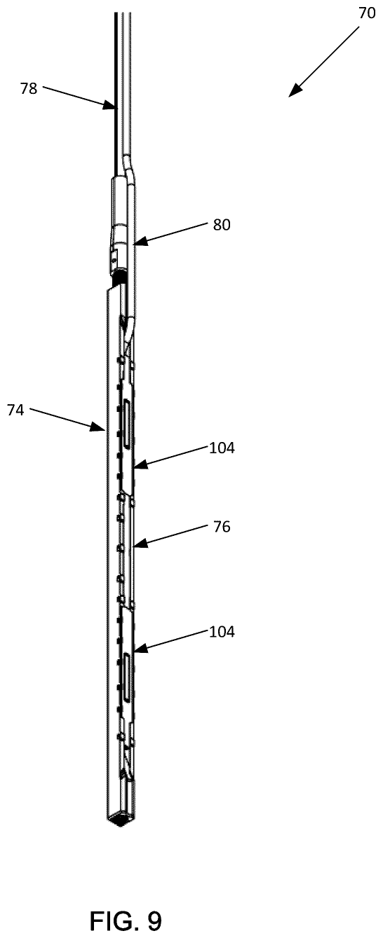

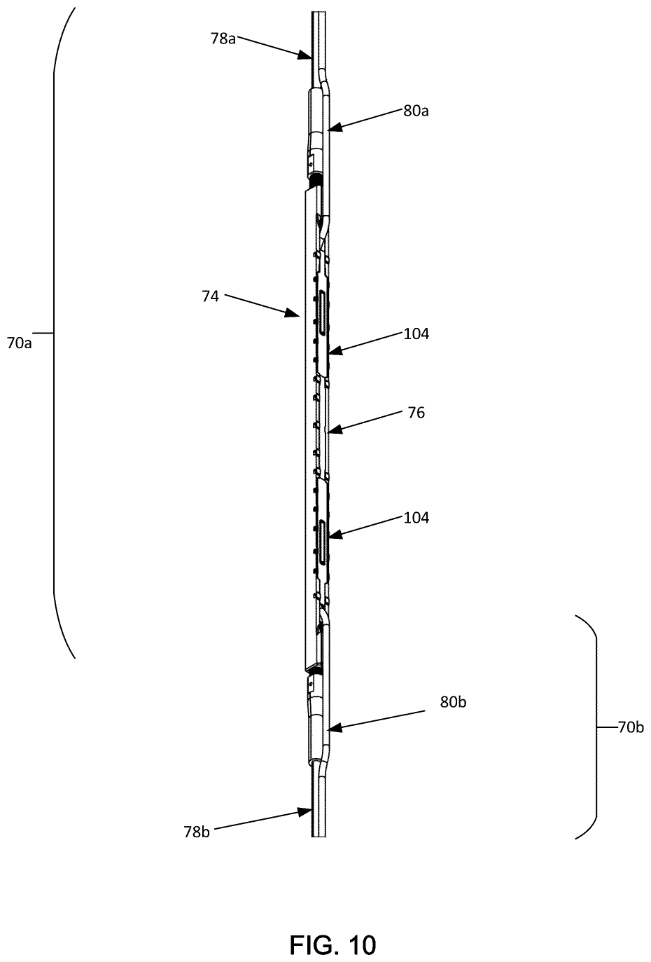

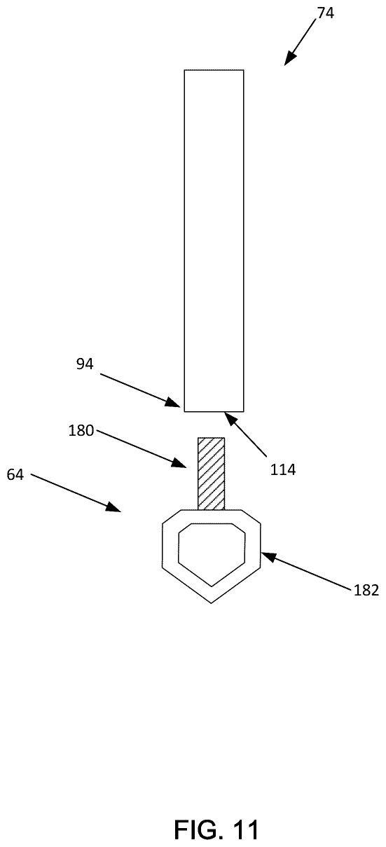

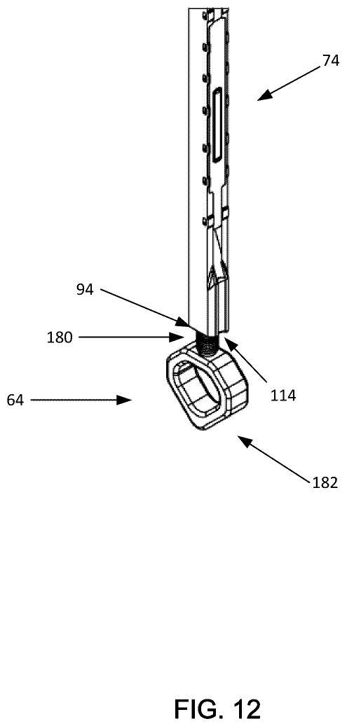

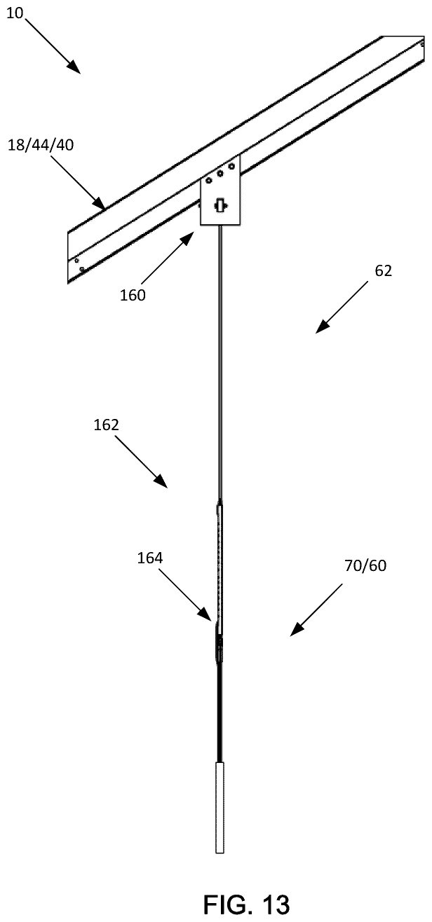

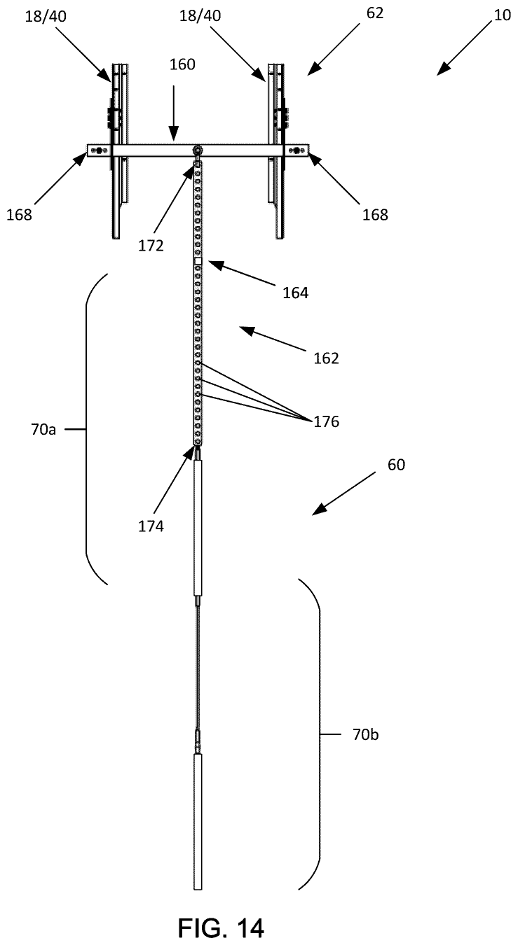

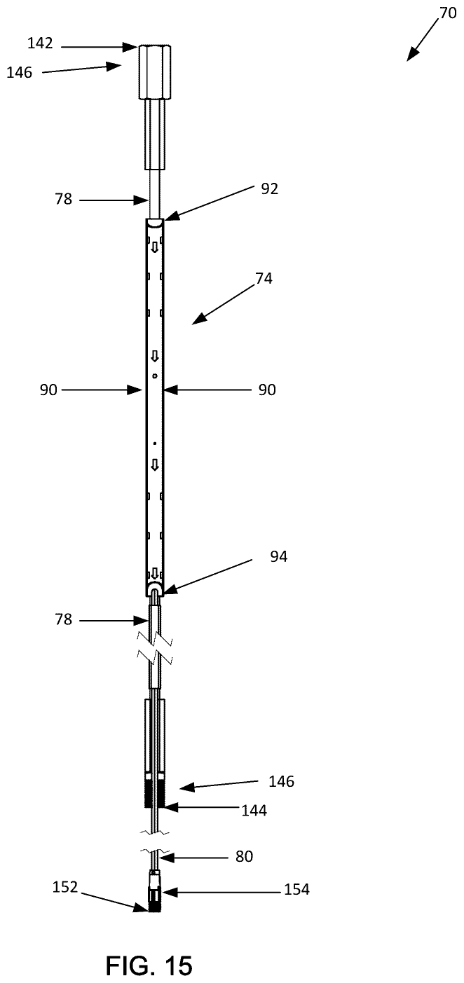

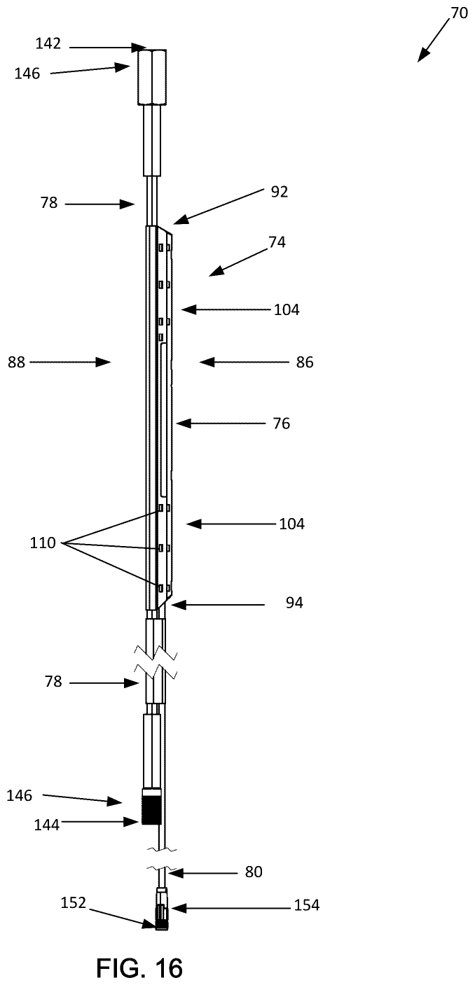

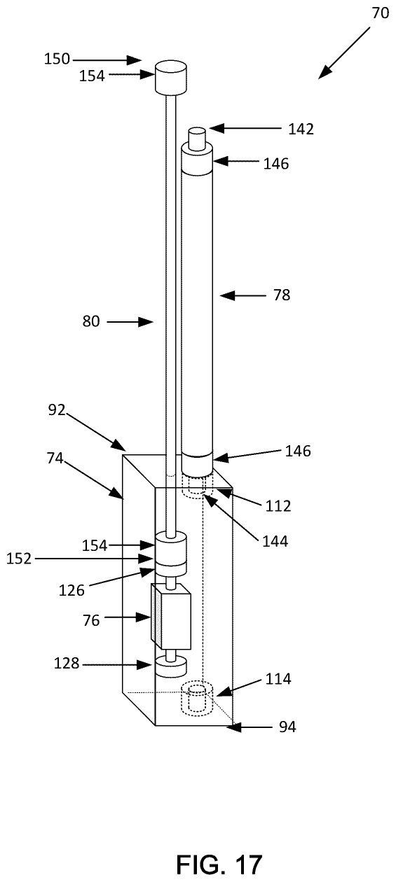

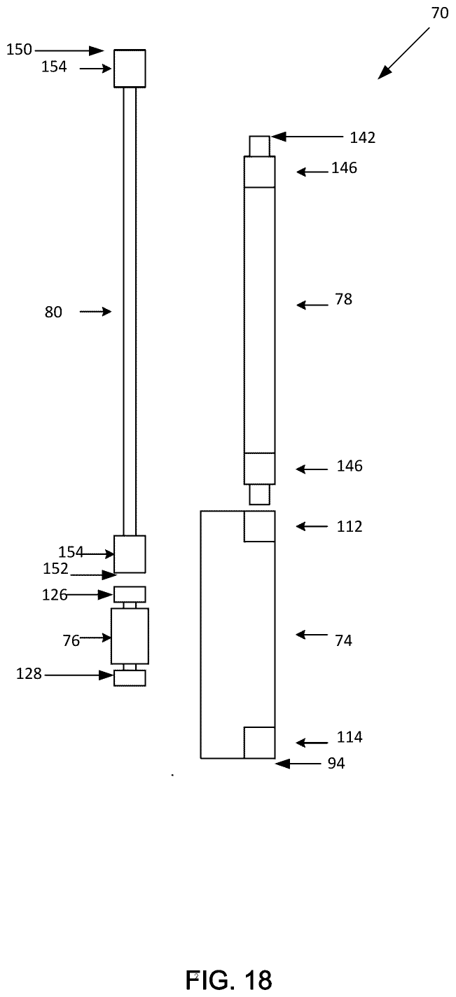

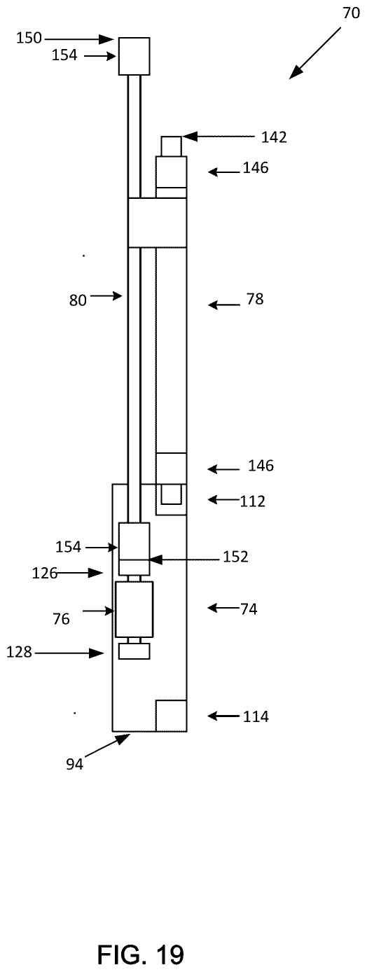

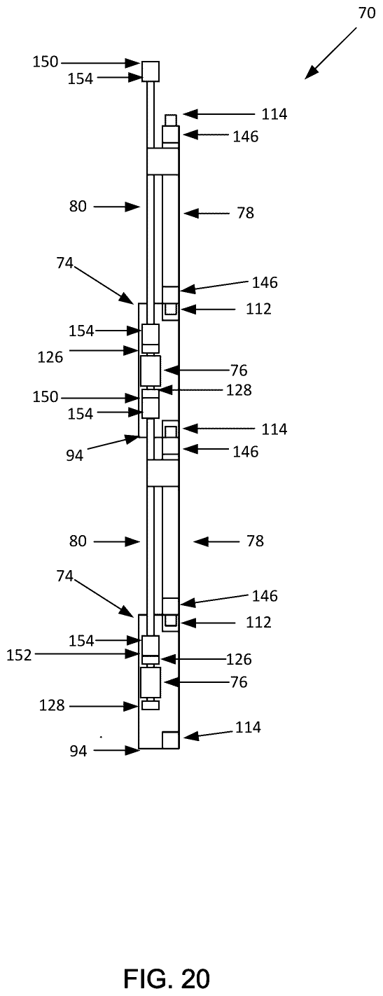

The arrangements shown in FIG. 1-20 are primarily shown and discussed as having weight of sensor cable segments 70 being transferred through and supported by the housing 74 in each sensor cable segment 70 of the multi-segment sensor cable 60. However, the embodiments are not so limited. Rather, it is contemplated that in one or more arrangements, weight of sensor cable segments 70 may be transferred through and supported entirely by the support cable 78 in each sensor cable segment 70, which extends the length of the sensor cable segment 70.

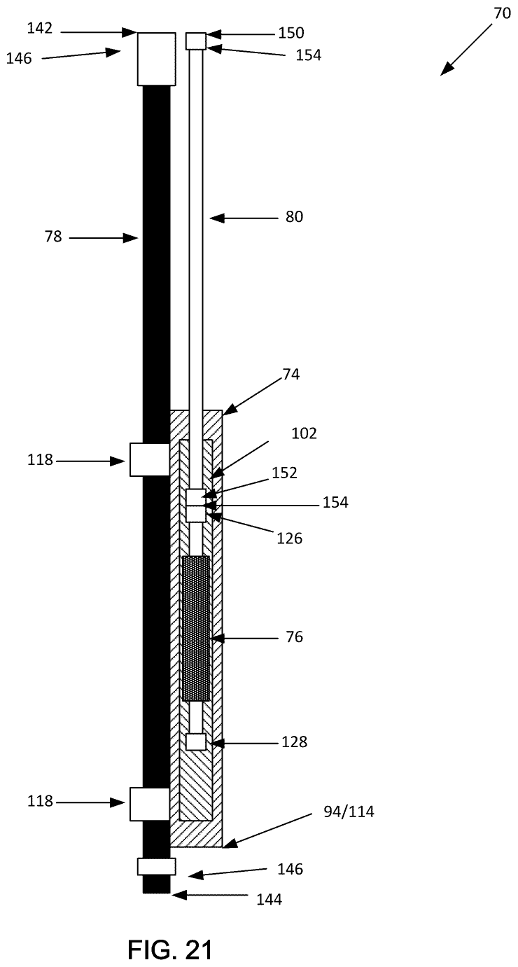

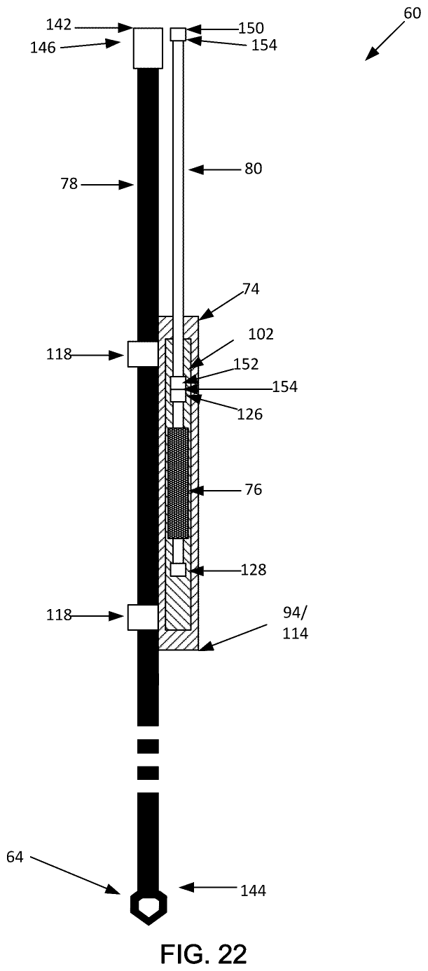

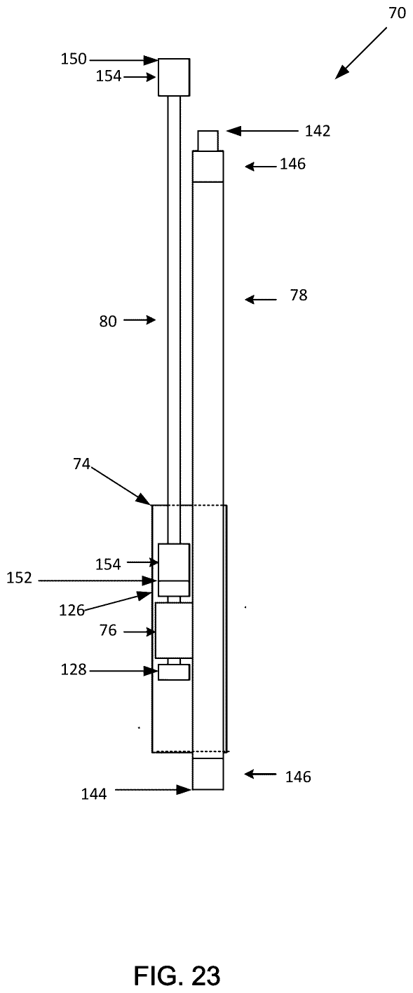

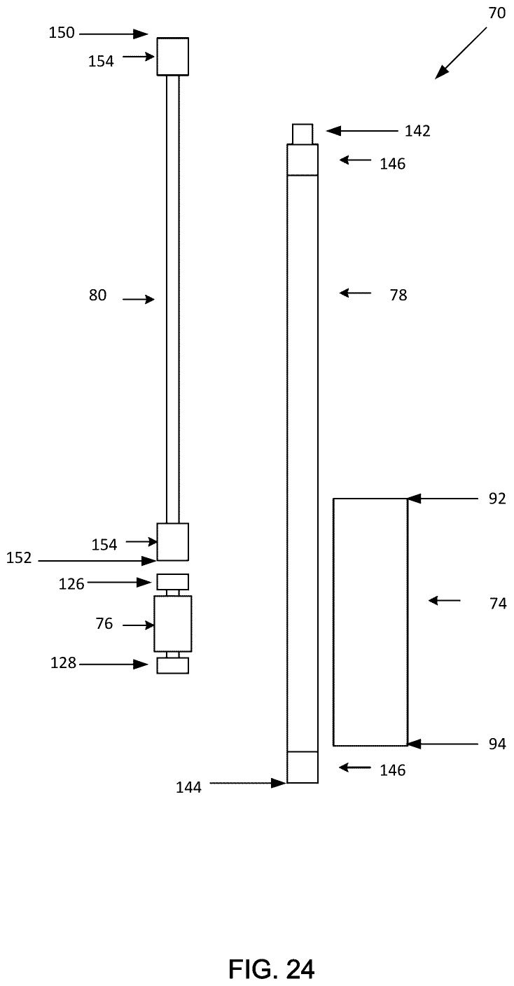

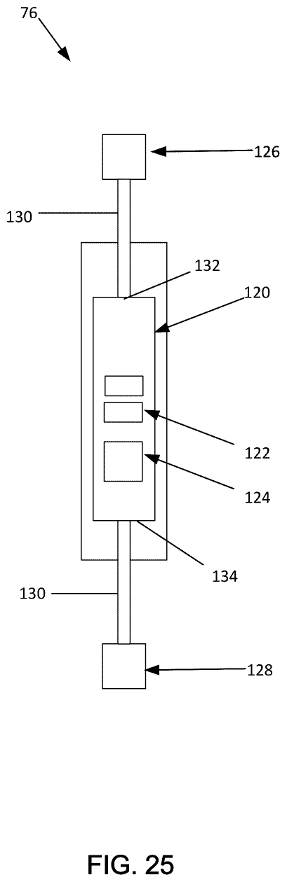

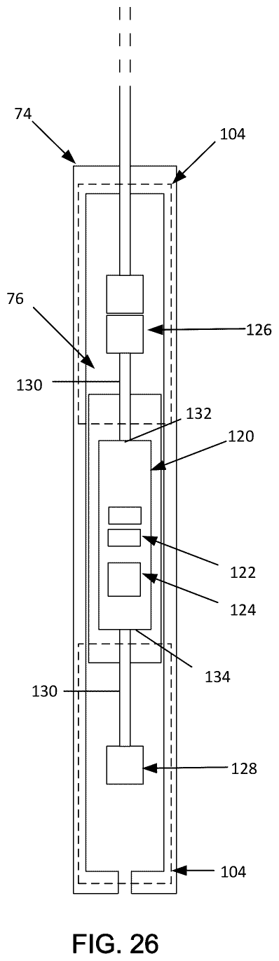

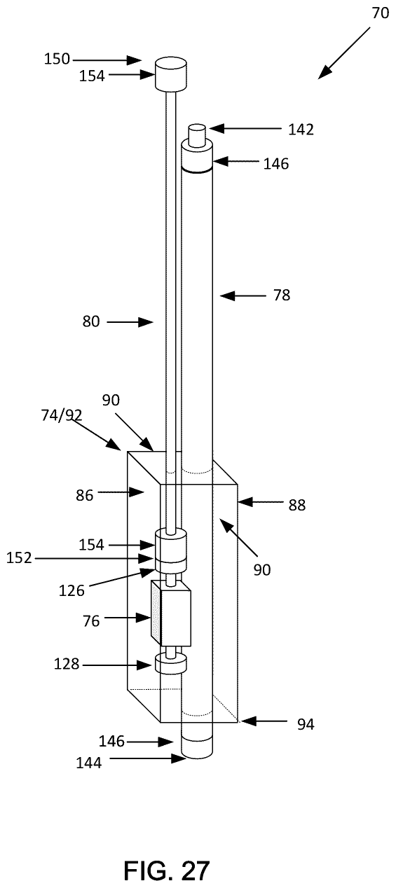

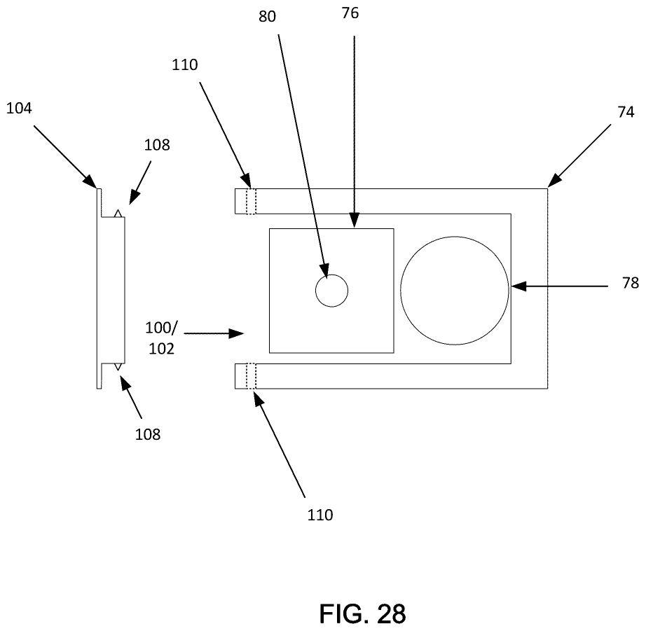

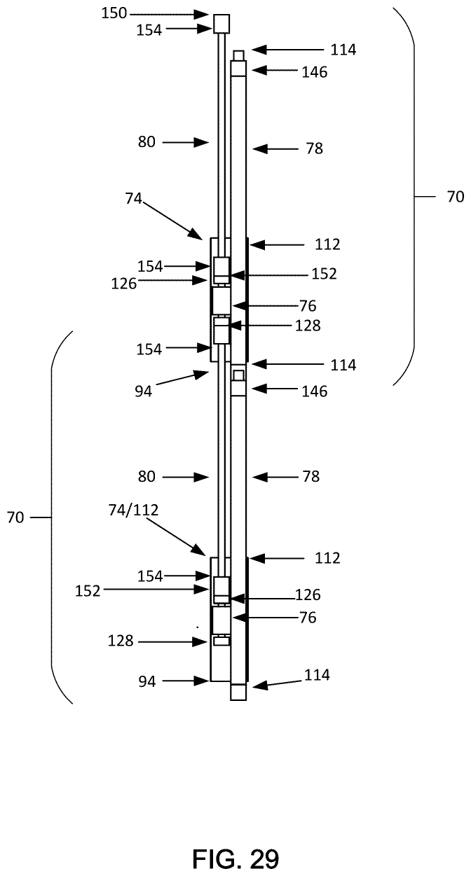

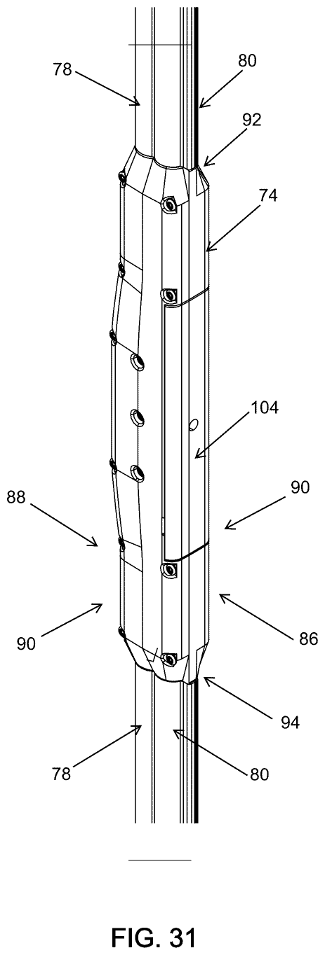

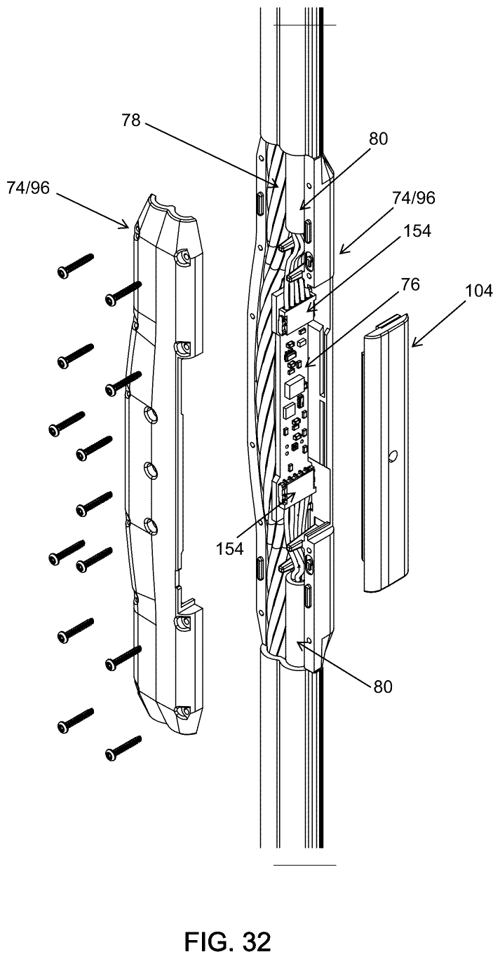

FIGS. 21-32 show example sensor cable segments 70 of such an alternative arrangement of system 10. The arrangements shown in FIGS. 21-32 are similar to the system 10 shown and discussed with reference to FIGS. 1-20 and as such the disclosure related to the arrangements shown in FIGS. 1-20 applies to the arrangements shown in FIGS. 21-32 unless stated specifically herein.

In the arrangement shown, as one example, support cable 78 extends the length of the sensor cable segment 70. In this example arrangement, termination connector 146 positioned at lower end 134 of support cable 78 is configured to connect with a termination connector 146 of upper end 142 of support cable 78 of another sensor cable segment 70 connected thereto. In the arrangement shown, as one example, upper connection feature 112 and lower connection feature 114 are omitted from housing 74. Rather, housing 74 is connected to support cable 78 by a set of cable connection features 118. In some example arrangements, cable connection features 118 connect support cable 78 to a side 90 of housing 74. As some other examples, support cable 78 extends through housing 74. In one or more arrangements, housing 74 includes cable connection features 118 within housing 74 that are configured to crimp onto support cable 78 to facilitate connection of housing 74 with support cable 78.

However, the arrangements are not so limited. Rather, it is contemplated that in one or more arrangements, cable connection features 118 connect support cable 78 to the interior and/or exterior of the front 86, back 88, sides 90, or any other portion of housing 74. Moreover, it is contemplated that in various arrangements, housing 74 may be connected to support cable 78 using various methods and/or means including but not limited to, eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof. In the arrangement shown, cable connection features 118 are loop brackets that extend around support cable 78 to clamp support cable 78 to housing 74. However, the embodiments are not so limited. Rather, it is contemplated that in some various different arrangements, cable connection features 118 may be implemented using various different types of methods or means for connecting including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof.

Because weight is supported by support cable 78 instead of housing 74, housing may be made of a wider variety of materials such as plastics that are, for example, less strong, lighter, cheaper, and/or are easier to manufacture.

Furthermore, while some arrangements may be primarily described with reference to a sensor cable segments 70 having a support cable 78 extends the length of the sensor cable segment 70, the embodiments are not so limited. Rather, it is contemplated that in one or more arrangements, a longer support cable 78 may span and support multiple sensor cable segments 78. For instance, in one or more arrangements, multi-segment sensor cable 60 may be implemented with a single support cable 78 spanning the length of the multi-segment sensor cable 60 and a plurality of sensor cable segments 70, each including a respective housing 74, sensor circuit 76, and data cable 80. This example arrangement may be useful to simplify installation of support cables while facilitating flexible installation and/or replacement of the sensor cable segments 78.

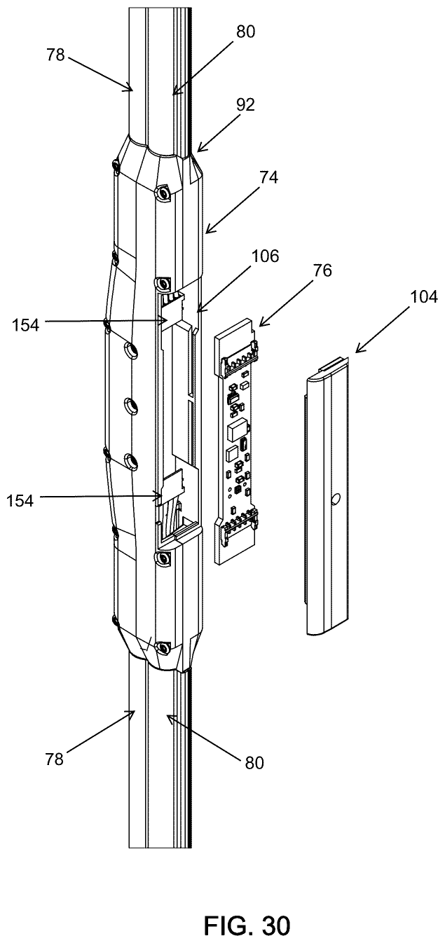

FIGS. 30-32 show an exemplary arrangement configured for use in a sensor cable having a single support cable 78 that spans the length of an entire sensor cable 60 and/or multiple sensor cable segments 70. In this example arrangement, support cable 78 runs alongside the data cables 80 and through the housings 74 of each sensor cable segment 70. The data cables and sensor circuits 76 and the sensor cable segments 70 are connected together in series to form a modular sensor cable 60.

In this example arrangements, as is shown, housing 74 is formed of two side halves 96. The halves 96 are configures to be positioned around support cable 78 and connected together to form a housing 74 that is operably connected with and supported by support cable 78. In this example arrangement, housing 74 has a contoured elongated generally rectangular shape having a front, back and sides extending from an upper end to a lower end. In this example arrangement, housing 74 has a removable cover 104 to provide access to a recess 100 or interior of housing 74 to facilitate access to and replacement of a sensor circuit 76.

For example, though an opening 106 provided by removal of cover 104, electrical connectors of data cables 80 can be disconnected from sensor circuit 76 and sensor circuit 76 removed while housing 74 and data cables 80 remain operably connected with and supported by supported be support cable 78. A new sensor circuit 76 can then be placed into housing 74 though the opening 106 and electrical connectors of data cables 80 then connected to the new sensor circuit to communicatively connect the complete modular sensor cable 60. The cover 104 is then reinstalled to enclose housing 74. As cables and housing do not need to be removed for replacement of sensor circuits 76, in one or arrangements, as is shown, support cable 78 and data cables 80 are wrapped or surrounded by a cable cover.

### Roof Access Port 200:

At various times, multi-segment sensor cable 60 may need to be accessed to facilitate, for example, installation, programing and/or reconfiguration of the sensor cable, resetting of the sensor cable, retrieving data measurements, and/or other maintenance. In one or more arrangements system 10 includes roof access ports 200 installed in roof 18 of grain bin 12 above sensor cables.

Roof access port 200 is formed of any suitable size, shape, and design and is configured to provide access to data cable 80 of an upper end of a multi-segment sensor cable 60 and/or a control module 210 connected thereto. In one or more arrangements as is shown, roof access port 200 includes a housing 202, a cover 204, a control module 210 positioned within housing, among other components.

### Housing 202:

Housing 202 is formed of any suitable size, shape, and design and is configured to be installed with and seal an opening 214 (not shown) of panel 34 of roof 18, provide access through the opening 214, and form a hollow interior 216 for housing control module 210 and/or other components of system 10 therein.

In the example arrangement shown, as one example, housing 202 has a generally cylindrical shaped main body 218 extending from an upper end 220 to a lower end 222. In this example arrangement, a lower flange 224 extends inward from lower end 222 and provides a surface to contact and form a seal with panel 34 of roof 18. However, in some arrangements, lower flange 224 may additionally or alternatively extend outward from lower end 222 of main body 218. In one or more arrangements, lower flanges 224 includes a set of holes 226 to facilitate connection with panel 34 of roof 18 (e.g., using fasteners 228 that extend through lower flange 224 and panel 34). In one or more arrangements, a ring shaped plate 234 is positioned below panel 34 and/or above lower flange 224 and has holes 236 aligned with holes 226 in ring shaped plate 234 and panel 34.

In one or more arrangements, ring shaped plate 234 is formed of a first half ring plate 244 and a second half ring plate 246. The use of half ring plates 244 and 246 facilitate insertion of ring shaped plate 234 though opening 214 in roof 18 for installation of roof access port from and exterior of grain bin 12. However, it is contemplated that various other shapes may be used for ring shaped plate 234 to facilitate insertion through opening 214 in roof 18. As one example, in some arrangements, plate 234 may have a C-shape permitting the plate 234 to be maneuvered through opening 214 in roof 18.

### Sealing Member 238:

In the arrangement shown, as one example, a sealing member 238 is positioned between lower flange 224 of main body 218 and panel 34 of roof 18. Sealing member 238 is formed of any suitable size, shape, and design and is configured to provide a watertight, airtight seal and/or a completely airtight seal between main body 218 of housing 202 and panel 34.

In one or more arrangements shown, as one example, sealing member 238 has a generally planar ring shape similar to a lower surface of lower flange 224 of main body 218 of housing. Additionally or alternatively, in one or more arrangements sealing member 238 may be an O-ring seated in a recess formed in a lower surface of lower flange 224. However, any other suitable shape for sealing member 238 is contemplated.

In one or more arrangements, sealing member 238 may be formed of any compressible food safe material that is capable of forming a suitable, watertight, airtight and/or completely airtight seal between main body 218 of housing 202 and panel 34 such as rubber, foam, plastic, composite, nylon, neoprene, a poly, or any other compressible material and/or combination thereof.

In this example arrangement, an upper flange 242 extends outward from upper end 220 of main body 218 and provides a surface to contact and form a seal with cover 204. panel 34 of roof 18. However, in some arrangements, lower flange 224 may additionally or alternatively extend inward from upper end 220 of main body 218.

### Cover 204:

Cover 204 is formed of any suitable size, shape, and design and is configured to operably connect with and enclose upper end 220 of main body 218. In the arrangement shown, as one example cover 204 has a generally planar disc shape having an upper surface 250 and lower surface 252 extending outward to an outer edge 254. In this example arrangement, cover 204 has a collar 256 that extends downward a distance from outer edge 254 to a lower edge 258.

### Connection Features 264/270

In one or more arrangements, cover 204 and housing 202 have respective connection features to facilitate connection of cover 204 with housing 202. In some various arrangements, connection features may include but are not limited to, for example: threads, interconnects, latches, pins, clamps, bolts, screws, and/or any other connection means. In the arrangement shown, as one example, housing has tab type connection features 264 configured for insertion into twist lock channel type connection features 266. In this example, twist lock channel type connection features 266 include a slotted channel 270 that extends along collar 256 from a first end 272 to a second end 274. In this example arrangement, the slotted channel 270 extends downward from the first end 272 to provide an opening 276 for cover 204 to fit tab type connection features 264 for insertion of tab type connection features 264 into the recessed channels 270. In the example arrangement, once cover 204 is placed over upper end 220 of housing 202 so tab type connection features 264 are positioned at the first end 272 of slotted channels 270. The cover 204 may then be rotated relative to housing to move tab type connection features 264 to the second end 274 of slotted channels 270, where cover 204 is held in place connected with housing 202. In one or more arrangements, slotted channels 270 is shaped so cover 204 is pulled closer onto upper end 220 of housing 202 as cover 204 is rotated to move tab type connection features 264 to the second end 274 of slotted channels 270. In one or more arrangements, as is shown,

In one or more arrangements, slotted channels 270 have a lock feature 278 configured to hold tab type connection features 264 at second end 274 of slotted channels 270 to prevent cover 204 from being inadvertently rotated and removed from upper end 220 of housing 202. In the arrangement shown, as one example, lock feature 278 is a protrusion positioned between the first end 272 and the second end 274 slotted channels 270 that tab type connection features 264 must ride over when being moved from the first end 272 to the second end 274. In this example arrangement, in order to move lock feature 278 from the second end 274, additional force must be applied to move tab type connection features 264 over the protrusion lock feature 278. In this manner, cover 204 is prevented from being inadvertently rotated and removed from upper end 220 of housing 202.

### Sealing Member 282:

In the arrangement shown, as one example, a sealing member 282 is positioned between cover 204 and upper end 220 of housing 202. Sealing member 282 is formed of any suitable size, shape, and design and is configured to provide a watertight, airtight seal and/or a completely airtight seal between cover 204 and upper end 220 of housing 202.

In one or more arrangements shown, as one example, sealing member 282 is an O-ring seated in a recess 284 formed in lower surface 252 of cover 204 and positioned to contact upper end 220 of housing 202 when cover 204 is placed on upper end of housing. However, any other suitable shape for sealing member 282 is contemplated. In one or more arrangements, sealing member 282 may be formed of any compressible food safe material that is capable of forming a suitable, watertight, airtight and/or completely airtight seal between cover 204 and upper end 220 of housing 202 such as rubber, foam, plastic, composite, nylon, neoprene, a poly, or any other compressible material and/or combination thereof. In this example arrangement, when cover 204 is placed on upper end 220 of main body 218 of housing 202 and rotated to lock cover 204 in position, sealing member 282 is compressed between upper end 220 and lower surface 252 of cover 204, thereby creating a watertight, airtight and/or completely airtight seal between cover 204 and upper end 220 of housing 202.

### Data Port 290

In one or more arrangements, housing 202 includes a data port 290. Data port 290 is formed of any suitable size, shape or design and is configured to provide a data path for data communication with a control module 210 positioned within housing 202 while maintaining a watertight, airtight and/or completely airtight seal of the closed housing 202. In one or more arrangements, data port 290 is positioned in an extends through main body 218 of housing 202 and includes a first electrical connector 292 positioned on an internal side of main body 218 and a second electrical connector 294 positioned on an external side of main body 218.

In one or more arrangements, an internal data cable 296 positioned within housing 202 connects first electrical connector 292 is connected with the control module 210 and an external data cable 298 connects second electrical connector 294 with a data network 300 for communication of sensor data to central data processing system 400.

Electrical connectors 292 and 294 are formed of any suitable size, shape, or design, and are configured to electrically connect an internal data cable 296 with external data cable 298. In various different arrangements, electrical connectors 126, 128, and 154 may be implemented using various different types of cable connectors including but not limited to, for example, DIN style connectors, Mini DIN style connectors, DB style connectors, 0.050 style connectors, VHDCI style connectors, Centronics style connectors, Mini Centronics style connectors, RJ style connectors, BNC style connectors, USB style connectors, FIREWIRE style connectors, Thunderbolt style connectors, DVI style connectors, mini DVI style connectors, HDMI DVI style connectors, fiber optic style connectors, coaxial style connectors, token ring style connectors, banana plug style connectors, spade style connectors, ring style connectors, XLR style connectors, other audio and/or video style connectors, power cord style connectors, and/or any other type of connector.

In some various arrangements, electrical connectors 292 and 294 may be the same type as electrical connectors 126, 128, and 154 or may be a different type of connector(s). Similarly, in some various arrangements, internal data cable 296 and external data cable 298 may be the same type of cable as data cable 80 or may be different type(s) of data cables.

In one or more arrangements, as is shown, control module 210 is connected to cover 204 by fasteners 286 (e.g., screws, bolts, etc.) that extend through holes 288 in control module 210 and into cover 204. With control module 210 connected to cover 204, the connection of cable 296 between control module 210 and housing 202 may assist to prevent the control module 210 and/or cover 204 from being accidentally dropped while cover is removed.

However, the arrangements are not so limited. Rather, it is contemplated that in various different arrangements, control module 210 may be secured within hollow interior 216 using various methods and/or means and may be secured to cover 204, housing 202 or any other suitable component and/or structure.

### Installation:

In one or more arrangements, roof access port 200 is configured to be installed from an exterior of grain bin 12. In one or more arrangements, an opening 214 is first formed in panel 34 or roof 18 from a top side of roof 18. In one or more arrangements, opening 214 is a circular opening formed using an appropriate sized circular cutting drill bit. However, in some various arrangements, opening 214 may be formed using various methods and/or means known in the art.

After forming opening 214, holes 248 (not shown) are drilled in panel 34, which are positioned to align with holes 236 in plate 234, holes 240 in sealing member 238, and/or holes 226 in lower flange 224 of housings 202. After drilling such holes 248 in panel 34, plate 234, sealing member 238 and housing 202 are installed. In this example installation, sealing member 238 is positioned along an edge of opening 214 on a top side of panel 34 with holes 240 of sealing member 238 aligned with holes 248 drilled in panel 34. Housing 202 is then placed over sealing member 238 with holes 226 of lower flange 224 aligned with holes 240 and 248.

In this example, a first half ring plate 244 of plate 234 is then inserted through hollow interior 216, open bottom of housing 202 and opening 214 of panel 34, and positioned along the edge of opening 214 on a bottom side of panel 34 with holes 236 aligned with holes 248 of panel 34. Fasteners 228 (e.g., bolts) are inserted upward through holes 236 first half ring plate 244 of plate 234, holes 248 in panel 34, holes 240 of sealing member 238, and holes 226 of lower flange 224 of housing 202 and connected (e.g., using nuts). This process is then repeated with the second half ring plate 246 of plate 234. In installing roof access port 200 using fasteners 228, plate 234 and clamp lower flange 224 and panel 34 against one another with sealing member 238 in between thereby providing a seal between panel 34 and housing 202. However, the arrangements are not so limited. Rather, it is contemplated that in some various arrangements one or both ring shaped plates 234 may be omitted.

In one or more arrangements, control module 210 is secured on a lower surface 252 of cover 204 by fasteners 286. Securing control module 210 to housing may beneficially provide easier access to connect data cables when cover 204 is removed. For installation of roof access port 200 for a pre-installed sensor cable 60, an upper most data cable 80 of the sensor cable 60 that is positioned below the opening 214 is fished or otherwise pulled upward through opening 214 and up through hollow interior of pulled up a connected to a first data port 310 of control module 210. In the arrangement shown, a second data port 312 of control module 210 is connected to electrical connector 292 of data port 290 in housing 202 by a short cable 296. Once data cables are connected, control module 210 is powered on and cover 204 is installed on housing 202 to close and seal hollow interior 216 and opening 214 or roof 18.

While the arrangements are primarily described with reference to a circular shaped opening 214 in roof 18 and cylindrical shaped housing 202, the arrangements are not so limited. Rather, it is contemplated that in some various arrangements, various components of roof access port 200 may be adapted for use with opening 214 of various shapes including but not limited to, for example, circular, oval, square, rectangular, triangular, or any other suitable shape.

### Data System 66:

In one or more arrangements, system 10 includes a data system 66. Data system 66 is formed of any suitable size, shape, and design and is configured to receive the sensor data from multi-segment sensor cables 60 in grain bin 12 to facilitate monitoring environmental conditions within grain bin 12 and/or performing automated tasks in response to the sensor data. In the arrangement shown, as one example, data system 66 includes control modules 210 communicative connected to respective multi-segment sensor cables and a central data processing system 400.

### Control Module 210:

Control module 210 is formed of any suitable size, shape, and design and is configured to receive data from sensor circuits 76 of sensor cable segments 70 of a multi-segment sensor cable 60. In one or more arrangements, control module 210 is further configured to communicate received data to a central data processing system 400 or other device. Additionally or alternatively, in one or more arrangements control module 210 may be configured to store received data for retrieval at a later time.

In the arrangements shown, as one example, control module 210 has a first data port 310 to facilitate connection with data cable 80 of a multi-segment sensor cable 60. In one or more arrangements, control module 210 also has a second data port 312, to facilitate connection with data network 300 via internal data cable 296 positioned without housing.

In various different arrangements, data ports 310 and 312 may be implemented using various different types of cable connectors including but not limited to, for example, DIN style connectors, Mini DIN style connectors, DB style connectors, 0.050 style connectors, VHDCI style connectors, Centronics style connectors, Mini Centronics style connectors, RJ style connectors, BNC style connectors, USB style connectors, FIREWIRE style connectors, Thunderbolt style connectors, DVI style connectors, mini DVI style connectors, HDMI DVI style connectors, fiber optic style connectors, coaxial style connectors, token ring style connectors, banana plug style connectors, spade style connectors, ring style connectors, XLR style connectors, other audio and/or video style connectors, power cord style connectors, and/or any other type of connector.

As previously described above, in one or more arrangements control module 210 is configured to automatically detect and determine positions of sensor circuits 76 of sensor segments 70 in the multi-segment sensor cable 60 when control module 210 is booted up or reset. Accordingly, any changes made to the multi-segment sensor cable 60 prior to boot up/reset (e.g., adding/replacing a sensor cable segment 70 and/or sensor circuit 76) are automatically accounted for.

In one or more arrangements, control module 210 includes a magnetic switch 302 (not shown) to facilitate easy reset and automated redetermination of sensor circuit 76 positions without needing to remove cover 204 from housing 202 of root access port 200. For example, in some arrangements, a user may initiate a reset by simply holding a magnet up to a designated portion of housing 202/cover 204. In some various different arrangements, magnetic 302 switch may be positioned within control module 210 or alternatively may be positioned in hollow interior 216 of housing 202/cover 204 and communication connected with control module. However, the arrangements are not so limited. Rather, it is contemplated that in some various arrangements control module 210 may be configured to initiate reset using various methods and/or means including but not limited to, for example, various wired or wireless switches or receipt of a command signal (e.g., via data network 300).

In some various different arrangements, control modules 210 may be configured to communicate data to central data processing system 400 using various wires and/or wireless of data networks and/or communication protocols including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, Modbus, 802.3/Ethernet, 802.11/WIFI, Wi-Max, Bluetooth, Bluetooth low energy, Ultra Wideband (UWB), 802.15.4/ZigBee, ZWave, GSM/EDGE, UMTS/HSPA+/HSDPA, CDMA, LTE, FM/VHF/UHF networks, and/or any other communication protocol, technology or network.

### Sensor Modules 320:

In one or more arrangements, sensor system 10 includes sensor modules 320 that are used in conjunction with sensors cables 60. Sensor modules 320 are formed of any suitable size shape, or design, and are configured to facilitate monitoring one or more environmental in the space above the grain in a grain bin. In one or more arrangements, as is shown, sensor modules 320 include a housing 322, a sensor circuit, 324, a bracket 326, and a data cable 328, among other components.

### Housing 322:

Housing 322 is formed of any suitable size, shape, and design and is configured to house a sensor circuit 324, facilitate connection of data cable 328 with sensor circuit 324, and operably connect with bracket 326 to facilitate mounting of the sensor 320 inside of the grain bin 12.

In one or more arrangements shown, as one example, housing 322 has a contoured elongated shape having a front 332, a back 334, and opposing sides 336 extending from an upper end 338 to a lower end 340. In this example arrangement, a data port 342 is positioned at upper end 338 of housing 322 to facilitate connection of data cables 328 with sensor circuit 324.

In one or more arrangements, as is shown, data cable 328 connected to sensor module 320 and data cable 298 connected to modular sensor cable 60 are connected to the same data port 290 of roof access port 200 by a splitter 330. However the arrangement are not so limited. Rather, it is contemplated that in some arrangements, data cables 328 and 298 may be connected to separate data ports of roof access port 200. Alternatively, it is contemplated that in one or more arrangements, sensor module 320 may have a second data port, to connect with data cable 298 connected to modular sensor cable 60, and be configured to relay data from modular sensor cable 60 to control module 210 of roof access port 200 via data cable 328.

### Sensor Circuit 324:

Sensor circuit 324 is formed of any suitable size, shape, and design and is configured to acquire data from one or more sensors and communicate the acquired data via data cable 328 to control module 210. In one or more arrangements, as one example, sensor circuit 324 includes a printed circuit board (PCB) 344 (not shown), one or more sensors 346 (not shown), a processing circuit 348 (not shown), and an electrical connector 350 (not shown), among other components.

In one or more arrangements, PCB 344, sensors 346, processing circuit 348, and electrical connectors 350 are similar to PCB 120, sensors 122, processing circuit 124, and electrical connectors 126/128 discussed with reference to sensor circuit 76. Unless specifically stated otherwise, all of the teaching and disclosure presented with respect to PCB 120, sensors 122, processing circuit 124, and electrical connectors 126/128 applies equally to PCB 344, sensors 346, processing circuit 348, and electrical connectors 350 of sensor circuit 324.

In one or more arrangements, sensor circuit 324 includes sensors 346 for measurement of CO2 pressure, temperature and/or humidity. However the arrangements are not so limited. Rather, it is contemplated that in some various arrangements sensor circuit 324 may include various sensors 346 configured to measure various additional or alternative environmental parameters.

### Bracket 326:

Bracket 326 is formed of any suitable size, shape, and design and is configured to operably connect with housing 322 to mount sensor module 320 to the interior of grain bin 12. In one or more arrangements, as is shown, bracket 326 is a U-shaped bracket having generally planar shaped bottom 354 and sides 356 extending upward from the bottom 354. In the arrangement shown, bracket has flanges 358 positioned at an upper ends of sides 356 of bracket 326 to facilitate mounting bracket on grain bin 12. In one or more arrangements, bracket 326 has an opening 360 and collar 362 at bottom 354 of bracket 326 that is configured to receive and hold a cylindrically-shaped lower end 340 of housing 322. In the arrangement shown, as one example, bracket includes a lock mechanism 364 configured to engage and hold lower end 340 of housing 322 of sensor module 320 in opening 360 and collar 362 at bottom 354 of bracket 326 while permitting sensor module 320 to be disconnected from bracket 326 for maintenance, replacement, and/or repair.

### Not Limited to Multi-Segment Sensor Cables 60:

While some various arrangements of roof access port 200 may be primarily described with reference to applications using multi-segment sensor cable 60, the arrangements are not so limited. Rather, it is contemplated that in some various arrangements roof access ports 200 may be adapted for use with various other types of modular or non-modular sensor cables.

### Central Data Processing System 400:

Central data processing system 400 is formed of any suitable size, shape, design and is configured to coordinate receipt, routing, and/or storage of data from sensors 122 to facilitate monitoring environmental conditions within grain bin 12 and/or performing automated tasks in response to the sensor data. As an illustrative example, in one or more arrangements, central data processing system 400 is configured to receive and store sensor data from control modules 210.

Additionally or alternatively, in one or more arrangements, central data processing system 400 is configured to perform various pre-programed actions in response to sensor data or user input from user interface 404 satisfying one or more trigger conditions. As some illustrative examples, some actions that may be initiated by central data processing system 400 in response to sensor data and/or user input from user interface 404 include but are not limited to, for example, controlling augers and conveyors of loading and/or unloading systems, controlling grain dryers, controlling environmental control systems (e.g., temperature control systems, air circulation systems, fumigation systems, and/or preservative application systems), and/or sending notifications to users (e.g., emails, SMS, push notifications, automated phone call, social media messaging, and/or any other type of messaging).

### User Interface 404:

User interface 404 is formed of any suitable size, shape, design, technology, and in any arrangement and is configured to facilitate user control and/or adjustment of various components of system 10. In one or more arrangements, as one example, user interface 404 includes a set of inputs (not shown). Inputs are formed of any suitable size, shape, and design and are configured to facilitate user input of data and/or control commands. In some various different arrangements, inputs may include various types of controls including but not limited to, for example, buttons, switches, dials, knobs, a keyboard, a mouse, a touch pad, a touchscreen, a joystick, a roller ball, or any other form of user input. Optionally, in one or more arrangements, user interface 404 includes a display (not shown) Display is formed of any suitable size, shape, design, technology, and in any arrangement and is configured to facilitate display information of settings, sensor readings, time elapsed, and/or other information pertaining to proper storage of contents of grain bin 12. In one or more arrangements, display may include, for example, LED lights, meters, gauges, screen or monitor of a computing device, tablet, and/or smartphone. Additionally or alternatively, in one or more arrangements, the inputs and/or display may be implemented on a separate device that is communicatively connected to control circuit 402. For example, in one or more arrangements, operation of control circuit 402 may be customized using a smartphone or other computing device that is communicatively connected to the control circuit 402 (e.g., via Bluetooth, WIFI, and/or the internet). In one or more arrangements, user interface 404 may be provided by a web-portal or software as a service (SaaS) application accessible over the internet.

In one or more arrangements, user interface 404 is configured to provide a dashboard for real time visualization sensor data and/or analytics derived data metrics to facilitate true understanding of conditions through grain bin 12 and how conditions change over time. Such monitoring is important because conditions within a grain bin 12 are rarely uniform. Crops are normally placed in grain bins 12 for storage at temperatures much warmer than winter temperatures. Since grains are good insulators, grain in the center of grain bin 12 will be at the same temperature as at harvest, even after outside temperatures have dropped well below freezing. The temperature difference may additionally cause migration of moisture within grain bin 12, which can lead to mold or spoilage.

The temperature difference may additionally cause migration of moisture within grain bin 12, which can lead to mold or spoilage. For example, air near the bin wall cools and sinks to bottom of grain bin 12, pushing air up in the center of the grain bin 12. When grain near the sidewalls 14 cools the warm air, moisture in the air condenses. Cool air cannot hold as much moisture as warm air. As this circulation continues, moisture begins to accumulate near top center of grain bin 12. Crusting is an indication of moisture accumulation and mold growth. Conversely, in spring and summer months when outside air gets warmer, moisture migration can occur in the opposite way and moisture will accumulate at bottom of grain bin 12. By monitoring conditions throughout a grain bin 12, appropriate action can be taken to mitigate damages when a hotspot or other condition indicative of an adverse condition is detected.

### Control Circuit 402:

Various blocks, modules, or other circuits of the control module 210, central data processing system 400, or other component of system 10 may be implemented to carry out one or more of the operations and activities described herein and/or shown in the figures. In these contexts, a “block” (also sometimes “logic circuit,” “control circuit,” “processing circuit,” “server,” “module,” “data processing system” or “system”) is a circuit specifically configured and arranged to carry out one or more of these or related operations/activities. For example, such circuits may be discrete logic circuits or programmable logic circuits configured and arranged for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, tablet, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain aspects are directed to a computer program product (e.g., nonvolatile memory device), which includes a machine or computer-readable medium having stored thereon instructions which may be executed by a computer (or other electronic device) to perform these operations/activities.

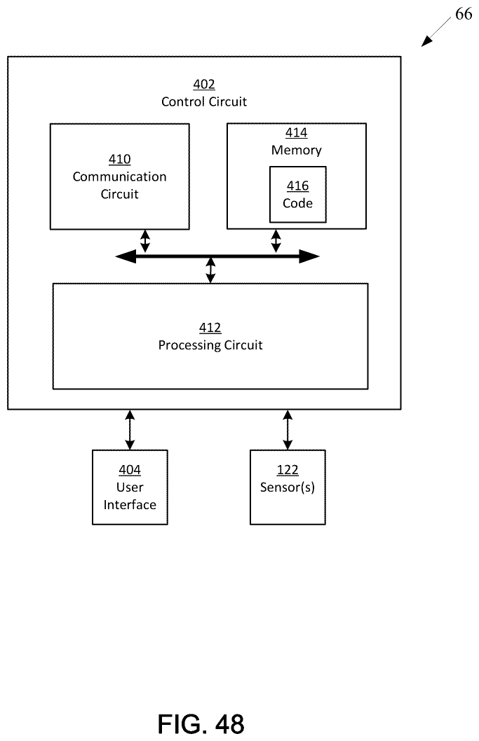

FIG. 48 shows an example control circuit 402 that may be used to implement systems, circuits, components, and/or processes of system 10, in accordance with one or more arrangements. Control circuit 402 is formed of any suitable size, shape, design, and/or technology and is configured to carry out the one or more of these or related operations/activities described herein. In the arrangement shown, as one example, control circuit 402 includes a processing circuit 412 and memory 414 having software code 416 or instructions that facilitates the processing and/or display of information, and a communication circuit 410, among other components.

Processing circuit 412 may be any computing device that receives and processes information and outputs commands according to software code 416 or instructions stored in memory 414. Memory 414 may be any form of information storage such as flash memory, ram memory, dram memory, a hard drive, or any other form of memory. Processing circuit 412 and memory 414 may be formed of a single combined unit. Alternatively, processing circuit 412 and memory 414 may be formed of separate but electrically connected components. Alternatively, processing circuit 412 and memory 414 may each be formed of multiple separate but electrically connected components.

Software code 416 or instructions is any form of information or rules that direct processing circuit 412 how to receive, interpret, and respond to information to operate as described herein. Software code 416 or instructions is stored in memory 414 and accessible to processing circuit 412. As an illustrative example, in one or more arrangements, software code or instructions may configure processing circuit 412 to interact with users via user interface 404 and perform various processes in response to user input.

Communication circuit 410 is formed of any suitable size, shape, design, and/or technology and is configured to facilitate communication with various other components of system 10 (as may be applicable). In one or more arrangements, as one example, communication circuit 410 includes a transceiver circuit and an antenna. A transceiver is any electronic device that facilitates two-way communication, that is, the delivery of information between control circuit 402 and other components of system 10. An antenna is any device that is configured to receive wireless signals from over-the-air communication and/or transmit wireless signals in over-the-air communication. In an example arrangement, a transceiver of communication circuit 410 is connected with a respective antenna, which may be a monopole antenna, dipole antenna, a loop antenna, a fractal antenna, or any other form of an antenna, to facilitate transmission and/or reception of signals in the form of electromagnetic radio frequencies. Additionally or alternatively, the transceiver of communication circuit 410 may be configured to communicate over a wired communication channel.

In various arrangements, communication circuit 410 may be configured to communicate with various components of system 10 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, 4G, 5G, FM/VHF/UHF networks, and/or any other communication protocol, technology or network.

Although in some arrangements, various circuits, components, systems, programs, or processes of system 10 may be primarily described or shown as being implemented together on the same system, machine, network, program or process, the arrangements are not so limited. Rather it is contemplated that such components, systems, programs, or processes of system 10 may be implemented separately by separate processes or programs and/or on separate circuits, systems, and/or components on the same bus or network or communicatively connected between different networks. Conversely, although in some arrangements, various circuits, components, systems, programs, or processes of system 10 may be primarily described or shown as being implemented separately, the arrangements are not so limited. Rather, it is contemplated that such components, systems, programs, or processes of system 10 may be implemented together by the same processes or program and/or on the same circuit, system, and/or component of system 10.

### Automated Monitoring and Control of Systems:

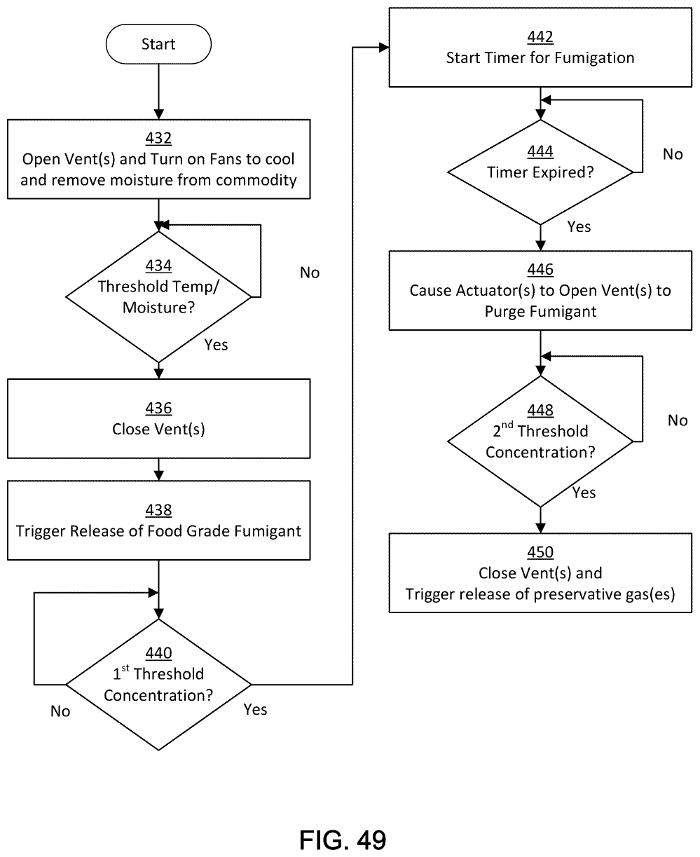

As an illustrative example, FIG. 49 shows a flow diagram of an example automated process that may be performed by a data system 66 in one or more arrangements. The process may be initiated by a user following loading of a commodity from a dryer into grain bin 12. In this example, the data system 66 opens roof vents 50 and turns on an air circulation system at process block 432 to cool and remove moisture from the commodity. The process then holds at decision block 434 until a threshold temperature is reached. Once the threshold temperature is reached, the process proceeds to process block 436, where data system 66 closes roof vents 50. At process block 438, data system 66 causes a fumigation system to release a food grade fumigant into grain bin 12. At decision block 340, data system 66 monitors concentration of the fumigant in grain bin 12 using one or more sensors until a first threshold concentration is reached. Once the first threshold concentration is reached, data system 66 initiates a timer at process block 442, to ensure that fumigate is applied for a sufficient amount of time to be effective (e.g., as instructed by the manufacture). The process then holds at decision block 444 until the timer has expired. Once the timer has expired, the process proceeds to process block 446, where data system 66 causes actuators to open roof vents 50 to purge the fumigant. At decision block 448, data system 66 monitors concentration of the fumigant in grain bin 12 using one or more sensors until a second threshold concentration that is safe for exposure is reached. In this example, once the second threshold concentration is reached, the process proceeds to process block 450, where data system 66 closes roof vents 50 and triggers release of a preservative (e.g. CO2) into grain bin 12 to prolong the shelf life of the commodity.

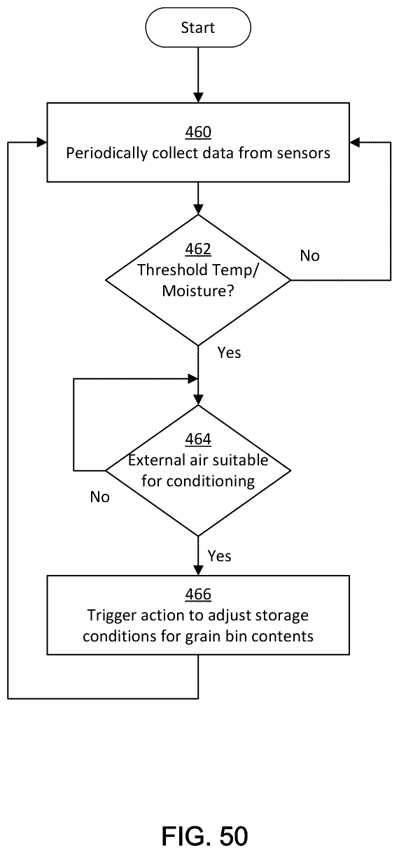

As another illustrative example, FIG. 50 shows a flow diagram of an example automated process that may be performed by a data system 66 to monitor long term storage in grain bin 12. At block 460, data system 66 periodically collects data from sensors of multi-segment sensor cables 60 of system 10. While temperature or moisture readings do not exceed a predetermined threshold indicative of a problem at decision block 462, no action is taken and the process loops back to process block 460 until the next set of data is collected. If temperature or moisture readings exceed a predetermined threshold indicative of a problem at decision block 462, the process continues to decision block 464. In this example, the process halts at decision block 464 if external conditions are not suitable to condition the grain in the grain bin 12 to address the issue. For example, if high levels of moisture are detected that would call for aeration of grain in grain bin 12 to further dry the grain, the process may halt at decision block 464 if humidity/temperature of external air would not efficiently dry the grain when aerated. If and when external conditions are suitable, the process continues to block 466, where control circuit 402 of data system 66 triggers action of one or more systems to address the problematic condition detected at decision block 462. Such actions may include but are not limited to, for example, aeration of grain to remove moisture, cooling of grain, heating grain, spreading and/or redistribute grain within bin, and/or any other operation performed to facilitate storage of grain. After such operation is performed, the process returns to block 460 until the next set of data is collected.

The automated operations performed by data system 66 in these illustrative examples, avoid numerous manual tasks by the user. Moreover, in one or more arrangements, data system 66 may perform many operations at the same time, thereby reducing overall processing time.

From the above discussion it will be appreciated that the sensor system presented herein improves upon the state of the art. More specifically, and without limitation, it will be appreciated that in one or more arrangements, a sensor system is presented: that monitors environmental conditions throughout a grain storage device; that permits real-time monitoring of environmental conditions throughout a grain storage device; that has multi-segment sensor cables that can be increased and decreased in length; that permits sensors to be replaced in the field without uninstalling sensor cables; that is durable; that is easy to manufacture; that is relatively inexpensive; that has a robust design; that is high quality; that is easy to install; that can be installed using conventional equipment and tools; that reduces grain bin corrosion; that reduces grain spoilage; and/or that can be used with any grain bin among other objects, features, or advantages.

It will be appreciated by those skilled in the art that other various modifications could be made to the device without parting from the spirit and scope of this disclosure. All such modifications and changes fall within the scope of the claims and are intended to be covered thereby.

What is claimed:

1. A multi-segment sensor cable system for a grain bin, comprising:
a multi-segment sensor cable;
the multi-segment sensor cable configured to be suspended from an upper end of the grain bin;
the multi-segment sensor cable having a plurality of sensor cable segments;
wherein the plurality of sensor cable segments each include:
a sensor circuit; and
one or more data cables communicatively connected to the sensor circuit;
wherein the one or more data cables of the sensor cable segments connect the sensor circuits of the sensor cable segments together in series to form the multi-segment sensor cable;
a roof access port configured to be installed over an opening in a roof of the grain bin;
the roof access port having a housing and a cover;
the housing having a hollow interior;
a control module positioned in the hollow interior;
wherein the control module is communicatively connected to the multi-segment sensor cable and is configured to receive data from the sensor circuits of the plurality of sensor cable segments.

2. The system of claim 1, wherein the roof access port includes a first seal between the housing and the roof;
wherein the roof access port includes a second seal between the housing and the cover.

3. The system of claim 1, wherein the roof access port includes a first airtight seal between the housing and the roof;
wherein the roof access port includes a second airtight seal between the housing and the cover.

4. The system of claim 1, wherein the roof access port includes a first watertight seal between the housing and the roof;
wherein the roof access port includes a second watertight seal between the housing and the cover.

5. The system of claim 1, wherein the control module is configured to perform a process to determine positions of the sensor circuits of the plurality of sensor cable segments in the multi-segment sensor cable.

6. The system of claim 1, wherein the control module is configured to perform a process to determine positions of the sensor circuits of the plurality of sensor cable segments in the multi-segment sensor cable in response to the control module being reset.

7. The system of claim 1, wherein the control module is configured to perform a process to determine positions of the sensor circuits of the plurality of sensor cable segments in the multi-segment sensor cable;
wherein the process includes transmitting a configuration token to the sensor circuits of the plurality of sensor cable segments one at a time from an uppermost one of the plurality of sensor cable segments in the multi-segment sensor cable to a lower most one of the plurality of sensor cable segments in the multi-segment sensor cable;
wherein the sensor circuit of each of the plurality of sensor cable segments is configured to communicate a unique identifier of the sensor circuit to the control module in response to receiving the configuration token.

8. The system of claim 1, wherein the control module is configured to perform a process to determine positions of the sensor circuits of the plurality of sensor cable segments in the multi-segment sensor cable;
wherein the process includes transmitting a configuration token to the sensor circuit of an uppermost one of the plurality of sensor cable segments in the multi-segment sensor cable;
wherein the sensor circuit of each of the plurality of sensor cable segments is configured to, in response to receiving the configuration token:
communicate a unique identifier of the sensor circuit to the control module; and
forward the configuration token to the sensor circuit of the next one of the plurality of sensor cable segments in the multi-segment sensor cable.

9. The system of claim 1, wherein the control module communicatively connected a magnetic switch positioned in the hollow interior;
wherein the control module is configured to reset in response to the magnetic switch being switched.

10. The system of claim 1, wherein the control module is configured to reset in response to receiving a control signal from a device communicatively connected to the control module.

11. The system of claim 1, wherein the control module is configured to transmit the received data to a data processing system.

12. The system of claim 1, wherein the plurality of sensor cable segments each include a housing enclosing the sensor circuit of the sensor cable segment.

13. The system of claim 1, wherein the multi-segment sensor cable includes a plurality of support cables of the plurality of sensor cable segments are configured to operably connect together in series to support the multi-segment sensor cable.

14. The system of claim 1, wherein the multi-segment sensor cable includes at least one support cable configured to support the weight of the plurality of sensor cable segments and prevent transfer of vertical forces through the data cables of the plurality of sensor cable segments.

15. A sensor cable system for a grain bin, comprising:
a sensor cable;
the sensor cable configured to be suspended from an upper end of the grain bin;
the sensor cable having a plurality of sensor circuits;
the sensor cable having a plurality of data cables;
wherein the plurality of data cables communicatively connect the plurality of sensor circuits together in series to form the sensor cable;
a roof access port configured to be installed over an opening in a roof of the grain bin;
the roof access port having a housing and a cover;
the housing having a hollow interior;
a control module positioned in the hollow interior;
wherein the control module is communicatively connected to the sensor cable and is configured to receive data from the plurality of sensor circuits.

16. The system of claim 15, wherein the roof access port includes a first seal between the housing and the roof;
wherein the roof access port includes a second seal between the housing and the cover.

17. The system of claim 15, wherein the roof access port includes a first airtight seal between the housing and the roof;
wherein the roof access port includes a second airtight seal between the housing and the cover.

18. The system of claim 15, wherein the roof access port includes a first watertight seal between the housing and the roof;
wherein the roof access port includes a second watertight seal between the housing and the cover.

19. The system of claim 15, wherein the control module is configured to perform a process to determine positions of the plurality of sensor circuits in the sensor cable.

20. The system of claim 15, wherein the control module is configured to perform a process to determine positions of the plurality of sensor circuits in the sensor cable in response to the control module being reset.

21. The system of claim 15, wherein the control module is configured to perform a process to determine positions of the plurality of sensor circuits in the sensor cable;
wherein the process includes transmitting a configuration token to the plurality of sensor circuits one at a time from an uppermost one of the plurality of sensor circuits to a lower most one of the plurality of sensor circuits;
wherein the sensor circuit of each of the plurality of sensor circuits is configured to communicate a unique identifier of the sensor circuit to the control module in response to receiving the configuration token.

22. The system of claim 15, wherein the control module is configured to perform a process to determine positions of the plurality of sensor circuits in the sensor cable;
wherein the process includes transmitting a configuration token to uppermost one of the plurality of sensor circuits;
wherein the plurality of sensor circuits configured to, in response to receiving the configuration token:
communicate a unique identifier of the sensor circuit to the control module; and
forward the configuration token to the next one of the plurality of sensor circuits in the sensor cable.

23. The system of claim 15, wherein the control module communicatively connected a magnetic switch positioned in the hollow interior;
wherein the control module is configured to reset in response to the magnetic switch being switched.

24. The system of claim 15, wherein the control module is configured to reset in response to receiving a control signal from a device communicatively connected to the control module.

25. The system of claim 15, wherein the control module is configured to transmit the received data to a data processing system.

26. The system of claim 15, wherein the plurality of sensor circuits are enclosed in respective ones of a plurality of housings.

27. The system of claim 15, wherein the sensor cable includes a plurality of support cables configured to be operably connect together in series to support the sensor cable.

28. The system of claim 15, wherein the sensor cable includes at least one support cable configured to support the weight of the sensor cable and prevent transfer of vertical forces through the plurality of data cables.

29. The system of claim 15, further comprising:
a sensor module;
a bracket configured for mounting the sensor module within the grain bin above at a position above grain stored in the grain bin;
wherein the control module is communicatively connected to the sensor module and is configured to receive data from the sensor module.

30. A sensor cable system for a grain bin, comprising:
a sensor cable;
the sensor cable configured to be suspended from an upper end of the grain bin;
the sensor cable having a plurality of sensor circuits;
the sensor cable having a plurality of data cables;
wherein the plurality of data cables communicatively connect the plurality of sensor circuits together in series to form the sensor cable;
a roof access port configured to be installed over an opening in a panel of a roof of the grain bin to facilitate access to an upper most one of the plurality of data cables;
the roof access port having a housing and a cover;
the housing having a hollow interior;
wherein the housing is configured to be connected to panel by:
a pair of semi ring shaped plates positioned below the panel and a set of fasteners that extend through holes in the pair of semi ring shaped plates, through holes in the panel, and through holes in a lower end of the housing.

31. The system of claim 30, wherein the pair of semi ring shaped plates are half ring shaped plates.

32. The system of claim 30, wherein the pair of semi ring shaped plates form a complete ring.

33. The system of claim 30, wherein the roof access port includes a seal between the housing and the panel.

34. The system of claim 30, wherein the roof access port includes an airtight seal between the housing and the panel.

35. The system of claim 30, wherein the roof access port includes a watertight seal between the housing and the panel.

36. A method for installing a roof access port for a grain bin, comprising:
providing a housing;
the housing having a generally cylindrical shape extending from a lower end to an upper end;
providing a cover;
the cover configured to attached to the upper end of the housing;
cutting a circular opening in a panel of the roof the sensor;
drilling a first set of holes in the panel adjacent the circular opening;
wherein the first set of holes in the panel align with a second set of holes in the lower end of the housing;
providing a ring shaped plate;
the ring shaped plate having a third set of holes that align with the second set of holes in the lower end of the housing;
the ring shaped plate having a diameter that is larger than a diameter of the circular opening in the panel;
wherein the ring shaped plate is formed by a first semi ring shaped plate and a second semi ring shaped plate;
positioning the housing user the circular opening with the second set of holes aligned with the first set of holes in the panel;
positioning the first semi ring shaped plate and the second semi ring shaped plate below the panel with the third set of holes aligned with the first set of holes in the panel;
connecting the housing with the panel using a set of fasteners that extend through the first set of holes, the second set of holes, and the third set of holes;
connecting the cover to the upper end of the housing.

37. The method of claim 36, wherein a first seal is positioned between the housing and the roof;
wherein a second seal is positioned between the housing and the cover.

38. The method of claim 36, wherein a first airtight seal is positioned between the housing and the roof;
wherein a second airtight seal is positioned between the housing and the cover.

39. The method of claim 36, wherein a first watertight seal is positioned between the housing and the roof;
wherein a second watertight seal is positioned between the housing and the cover.

40. A sensor cable system for a grain bin, comprising:
an access port positioned over an opening in a roof of the grain bin;
wherein the access port has a cover configured to move between a closed position and an open position;
a sensor cable;
a bracket;
wherein the bracket is operably connected to a roof of the grain bin;
wherein the sensor cable is connected to the bracket;
wherein the sensor cable is positioned below the access port and is accessible through the access port with the cover in the open position;
a control module;
wherein the control module is operably connected to the grain bin at a position accessible though the access port with the cover in the open position;
wherein the control module is communicatively connected to the sensor cable and is configured to receive data from sensor cable.

41. The system of claim 40, further comprising:
a sensor module;
a bracket configured for mounting the sensor module within the grain bin at a position accessible from the access port;
wherein the control module is communicatively connected to the sensor module and is configured to receive data from the sensor module.
